(19) United States
(12) Patent Application Publication
(10) Pub. No.: US 2023/0234282 A1
(43) Pub. Date: Jul. 27, 2023

(54) ELECTROCHEMICAL PRINTER AND METHOD FOR FORMING A MULTIDIMENSIONAL STRUCTURE

(71) Applicant: SPARK3D PTY LTD, Acton ACT (AU)

(72) Inventors: Luke A. Connal, Canberra, Australian Capital Territory (AU); Jekaterina Viktorova, Canberra, Australian Capital Territory (AU)

(21) Appl. No.: 18/007,160

(22) PCT Filed: Jul. 28, 2021
(86) PCT No.: PCT/AU2021/050822

§ 371 Date: Jan. 27, 2023

(30) Foreign Application Priority Data
Jul. 29, 2020 (AU) 2020902658

(51) Int. Cl. B29C 64/124; B29C 64/393; C25D 1/00; C25D 17/10; C25D 17/28

(52) U.S. Cl. CPC B29C 64/124; B29C 64/393; C25D 1/003; C25D 17/10; C25D 17/28; B33Y 10/00

(57) ABSTRACT

The present invention relates to a method for forming a multidimensional structure, comprising: providing an electrode and a substrate in a fluid, wherein the fluid comprises an electrolyte and a precursor agent dispersed therein; applying an electric potential difference between the substrate and the electrode to reduce or oxidise the precursor agent, thereby depositing a solid material; measuring current between the substrate and the electrode; and moving the electrode within the fluid to form a multidimensional structure of the solid material. Also provided is a device for forming a multidimensional structure.

### CROSS REFERENCE

The present application derives priority from Australian provisional application number 2020902658, filed on 29 Jul. 2020, the entire contents of which is incorporated herein by reference in its entirety.

### FIELD

The invention relates to a method for forming a multidimensional structure. The invention also relates to a printer which uses the method.

### BACKGROUND

Additive manufacturing (AM), commonly known as 3D printing, has been revolutionizing both industry and academia through: creating opportunities for improving sustainability; enabling cheap and rapid prototyping; allowing products to be customized individually; and enabling the formation of highly defined complex 3D geometries. Due to the technologies' ability to produce structures on the scale from nanometer to meter, 3D printing has been applied to areas such as biomaterials, aerospace, drug delivery, electrocatalytic applications and printed electronics.

As such, the improvement of 3D printable novel materials and technologies is driving growth in this field. Despite many types of materials having been developed and adopted for 3D printing, including various polymers, metals, ceramics and composites, the lack of methods that allow for printing of multiple material systems using a single additive manufacturing method has emerged as a bottleneck in further development of this technology for more advanced applications. It is due to the difference in deposition technology behind the specific AM methods, that multi-material 3D printers that allow for printing polymers, metals and inorganic materials in a single device are not presently available.

With respect to printing metal structures, some AM processes such as Selective Laser Melting (SLM) and Electron Beam Melting (EBM) are capable of producing metal parts with high precision, however they both suffer from very high residual stresses due to the complete melting of the material during manufacturing and require high energies for deposition and high upfront investment in equipment or infrastructure. Other inorganic materials, such as ceramics and semiconductors, while suitable for inkjet printing, often require a curing step after printing, in order to achieve the desired material composition, functionality and microstructure. Accordingly, there is need for printing methods and printers that are able to print pure metals, semiconductors and polymers without extensive post-processing steps.

In addition, current extrusion-based printing methods are limited to resolutions of 200-1000 μm due to the nozzle size, posing a limitation for an affordable 3D printing method for biomaterial or electronics applications requiring high resolution printing. While the more costly AM methods such as inkjet printing, stereolithography (SLA) and two photon 3D printing (TPP) allow for 10-50 μm, ˜1 μm and less than 100 nm resolution respectively, the printable materials are limited by the printing mechanism and are often proprietary to the manufacturer of the machine. Moreover, they can have reduced structural properties due to the vertical layering of the material and lack of functionality, constraining the application and quality of the printed structures. Accordingly, there is a need to develop new AM methods that are able to produce structures in high resolution that do not suffer from the limitations of the previous AM methods in the art.

Further, there are difficulties in printing pure conductors in a range of 3D geometries, while maintaining high conductivity of the printed material using AM methods known in the art. There are currently many dimensional constraints on the production of conductive polymer structures (e.g. the polymers themselves are unsuitable for direct processing as they are typically insoluble, making manufacture of complex shapes and characterisation of the polymers themselves difficult). Independent of the method of formation, there are currently several challenges in utilizing conductive polymers (CP) for miniaturized devices: (1) lack of a manufacturing method that enables a high degree of control over the deposited microstructure in all three dimensions; (2) characterization of the manufactured devices is often complex; (3) deposition speed is too slow.

Some of the methods that have been attempted for micro-/nano-scale fabrication using CPs are: (a) conventional cleanroom lithography; (b) atomic force microscope (AFM) dip-pen nanolithography; (c) AFM scratch lithography; (d) cantilever-based electrochemical deposition; (e) integrated microfluidic systems; (f) scanning electrochemical microscope (SECM); (g) electrohydrodynamic jet printing; (h) inkjet printing; and (i) electropolymerization. All of the above mentioned fabrication methods have their benefits and limitations, however most of them either require a high upfront investment, are lacking in their control of the fabricated structure, or lack in resolution of the printed structure. Accordingly, there is a need to develop new AM methods that enable precise dimensional control for printing highly conductive polymer structures for, e.g., microelectronics applications.

It is an aim of the present invention to at least partially satisfy at least one of the above needs.

### SUMMARY OF INVENTION

The inventors of the present invention have surprising found that by using localized electrodeposition resulting from an applied oxidation or reduction potential between an electrode and a substrate within a container of dissolved electro-depositable material, they have been able to create three dimensional structures in a controlled manner.

In particular, by measuring the current between the electrode and substrate during the deposition process, they have surprising found that the method may enable the ability to monitor and control deposition processes in situ, thereby allowing precise monitoring of reactions at electro-depositable material concentrations as low as 10⁻³ to 10⁻⁵ M, and enabling control of printing parameters in real time using data from the monitoring. Further, the method may be suitable for forming structures made from a variety of materials, including conductive and insulating polymers, semiconductors and metals. The method may also be suitable for producing structures comprising more than one type of material, i.e. multi-material printing.

According to a first aspect of the invention there is provided a method for forming a multidimensional structure, the method comprising the following steps:

providing an electrode and a substrate in a fluid,
wherein the fluid comprises:
   an electrolyte, and
   a precursor agent dispersed therein;

applying an electric potential difference between the substrate and the electrode to reduce or oxidise the precursor agent, thereby depositing a solid material;

measuring current between the substrate and the electrode; and

moving the electrode within the fluid to form a multidimensional structure of the solid material.

The following options may be used in conjunction with the first aspect, either individually or in any suitable combination.

The current between the substrate and the electrode may be measured at a plurality of time points. In certain embodiments, the time points are from about 100 μs to about 1 second apart.

In certain embodiments, the current between the substrate and the electrode is measured as a function of time.

The method may further comprise varying one or more of the electrical potential difference between the substrate and the electrode, and the position of the electrode when the current is above, below, or at a predetermined value. In certain embodiments, the method comprises increasing the electric potential difference between the substrate and the electrode, and/or decreasing the distance between the electrode and the substrate or multidimensional structure, when the current is below the predetermined value.

The method may comprise adjusting the electrical potential from a first voltage to a second voltage. In certain embodiments the method comprises cycling the electrical potential between the first voltage and second voltage. The cycling may comprise varying the electrical potential difference from the first voltage to the second voltage and back to the first voltage, wherein the absolute average rate of change in electric potential difference when varying the electric potential difference from the first voltage to the second voltage is substantially the same as when varying the electric potential difference from the second voltage back to the first voltage.

In certain embodiments, the cycling does not comprise voltage pulses.

The time for one cycle from the first voltage to the second voltage and back to the first voltage may be 100 μs or more.

The precursor agent may be selected from the group consisting of metal salts and monomeric materials.

The concentration of the precursor agent in the fluid may be from about 10⁻⁵ M to about 1.5 M.

The fluid may be in a container, and the electrode and substrate may be within the fluid in the container.

The fluid may comprise an organic solvent. The organic solvent may be acetonitrile.

In certain embodiments, the fluid does not comprise water.

The solid material may be selected from the group consisting of vinyl polymers, conjugated polymers, metals, and combinations thereof.

In certain embodiments, the solid material is selected from the group consisting of polypyrrole, poly(3,4-ethylenedioxythiophene), polythiophene, polyaniline, poly(3,4-ethylenedioxythiophene) polystyrene sulfonate (PEDOT:PSS), polypyrrole:dopamine copolymer, polyvinylimidazole, and copper.

The precursor agent may be selected from the group consisting of metal ion salts, metal ion complexes, ionic liquids, vinyl monomers, and monomers of conjugated polymers.

In certain embodiments the precursor agent is selected from the group consisting of aniline, pyrrole, thiophene, 3,4-ethylenedioxythiophene, vinylimidazole, and copper salts.

The electrolyte may comprise tetrabutylammonium hexafluorophosphate (TBAHFP).

In certain embodiments, the fluid is a first fluid, and the method further comprises:

replacing the first fluid with a second fluid, wherein the second fluid comprises:
an electrolyte, and
a precursor agent dispersed therein, wherein the precursor agent of the second fluid is different to the precursor agent of the first fluid; and

applying an electrical potential difference between the electrode and the substrate to reduce or oxidise the precursor agent of the second fluid, thereby depositing a second solid material.

In certain embodiments, the fluid comprises a first precursor agent and a second precursor agent, and the method comprises:
applying a first electrical potential difference between the electrode and the substrate to reduce or oxidise the first precursor agent, thereby depositing a first solid material; and
applying a second electrical potential difference between the electrode and the substrate to reduce or oxidise the second precursor agent, thereby depositing a second solid material.

In certain embodiments, the first precursor agent is EDOT, the first solid material is PEDOT, the second precursor agent is vinylimidazole, and the second solid material is polyvinylimidazole.

The electrode may be a microelectrode or nanoelectrode. The surface area of the electrode may be from about 10⁻⁹ m² to about 10⁻⁴ m².

The electrode may comprise platinum, carbon, or gold.

The substrate may comprise indium tin oxide (ITO), silicon, aluminium, steel, gold, or a combination thereof.

The multidimensional structure may be a three-dimensional structure. It may be electrically conductive. In certain embodiments it may be a composite structure.

In certain embodiments there is provided a method for forming a multidimensional structure, the method comprising the following steps:

providing an electrode and a substrate in a fluid,
wherein the fluid comprises:
   TBAHFP, and
   pyrrole in acetonitrile;

applying an electric potential difference between the substrate and the electrode to oxidise the pyrrole, thereby depositing polypyrrole;

measuring current between the substrate and the electrode; and

moving the electrode within the fluid to form a multidimensional structure of the polypyrrole;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   EDOT in acetonitrile;
applying an electric potential difference between the substrate and the electrode to oxidise the EDOT, thereby depositing PEDOT;

measuring current between the substrate and the electrode; and

moving the electrode within the fluid to form a multidimensional structure of the PEDOT;

wherein the current between the substrate and the electrode is measured as a function of time;
and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   thiophene in acetonitrile;

applying an electric potential difference between the substrate and the electrode to oxidise the thiophene, thereby depositing polythiophene;

measuring current between the substrate and the electrode; and

moving the electrode within the fluid to form a multidimensional structure of the polythiophene;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   aniline in acetonitrile;

applying an electric potential difference between the substrate and the electrode to oxidise the aniline, thereby depositing polyaniline;

measuring current between the substrate and the electrode; and

moving the electrode within the fluid to form a multidimensional structure of the polyaniline;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   vinylimidazole in acetonitrile;

applying an electric potential difference between the substrate and the electrode to oxidise the vinylimidazole, thereby depositing polyvinylimidazole;

measuring current between the substrate and the electrode; and

moving the electrode within the fluid to form a multidimensional structure of the polyvinylimidazole;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP,
   EDOT, and
   vinylimidazole in acetonitrile;

applying a first electric potential difference between the substrate and the electrode to oxidise the EDOT, thereby depositing PEDOT;

applying a second electrical potential difference between the substrate and the electrode to oxidise the vinylimidazole, thereby depositing polyvinylimidazole;

measuring current between the substrate and the electrode; and

moving the electrode within the fluid to form a multidimensional structure of the PEDOT and polyvinylimidazole;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   Cu²⁺ in acetonitrile;

applying an electric potential difference between the substrate and the electrode to reduce the Cu²⁺, thereby depositing copper;

measuring current between the substrate and the electrode; and

moving the electrode within the fluid to form a multidimensional structure of the copper;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP,
   EDOT, and
   Cu²⁺;

applying a first electric potential difference between the substrate and the electrode to oxidise the EDOT, thereby depositing PEDOT;

applying a second electrical potential difference between the substrate and the electrode to reduce the Cu²⁺, thereby depositing copper;

measuring current between the substrate and the electrode; and

moving the electrode within the fluid to form a multidimensional structure of the PEDOT and copper;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In a second aspect there is provided a device for producing a multidimensional structure, said device comprising:
an electrode;
a container for holding a fluid;
one or more motors for moving the electrode within the container;
a substrate within the container; and
a potentiostat for applying an electric potential difference between the substrate and the electrode and for measuring current between the substrate and the electrode, which allows for the in situ monitoring of the printing process.

The following options may be used in conjunction with the second aspect, either individually or in any suitable combination.

The device may further comprise a reference electrode in electrical connection to the potentiostat.

The device may further comprise a quartz crystal microbalance (QCM) for measuring the mass of the multidimensional structure.

In certain embodiments, the device comprises three motors.

In certain embodiments, the device is a 3D printer.

The device according to the second aspect may be used in the method according to the first aspect. The method according to the first aspect may use the device according to the first aspect.

In a third aspect there is provided a multidimensional structure which is formed using the method of the first aspect.

The following options may be used in conjunction with the third aspect, either individually or in any suitable combination.

The multidimensional structure may be a three-dimensional structure. It may be electrically conductive. In certain embodiments it may be a composite structure.

The device according to the second aspect may be used to produce the multidimensional structure according to the third aspect. The multidimensional structure according to the third aspect may be produced using the device according to the second aspect.

In a fourth aspect there is provided a printer when used to print a multidimensional structure according to the method of the first aspect.

The following options may be used in conjunction with the fourth aspect, either individually or in any suitable combination.

The printer may be a 3D printer.

The printer according to the fourth aspect may be the device according to the second aspect. The device according to the second aspect may be the printer according to the fourth aspect.

### BRIEF DESCRIPTION OF DRAWINGS

FIG. 1: Images of electrodes used for the example printing methods: (A) a nanoelectrode; (B) a microelectrode.

FIG. 2: Depiction of an example multidimensional printer device.

FIG. 3: Depiction of an example printing process.

FIG. 4: A schematic diagram of an example device for printing a multidimensional structure. FIG. 4(A) shows the entire device in a top-down view. FIGS. 4(B) and 4(C) show expanded regions of the device in perspective and front elevation views, respectively.

FIG. 5: Image of an example PEDOT pillar printed from 70 mM EDOT and 97 mM TBAHFP in acetonitrile, using a cell potential E_{cell}=3.5V, measuring the current every 0.1 s and using an electrode movement speed of 0.1 mm/s for 10 s.

FIG. 6: Raw and normalized chronoamperometry data for: PEDOT structures printed from a solution comprising 70 mM EDOT and 97 mM TBAHFP in acetonitrile; and baseline prints in a solution comprising 97 mM TBAHFP in acetonitrile. Raw chronoamperometry data was acquired at a cell potential E_{cell}=3.5V, with current measured every 0.1 s. (A): Three upward pillar prints of PEDOT (Print 1, 2, 3) alongside three prints in the absence of the monomer (Neg 1, 2, 3). (B): Normalized chronoamperometry data for three upwards pillar prints of PEDOT after subtraction of the baseline (average of three negative control prints: inset graph).

FIG. 7: An averaged charge curve calculated from the normalized chronoamperometry data for prints from EDOT solution (70 mM EDOT and 97 mM TBAHFP in acetonitrile). The chronoamperometry data was acquired at a cell potential E_{cell}=3.5V, with current measured every 0.1 s.

FIG. 8: Computer-aided design (CAD) render of the printed copper interdigitated structure (bottom layer).

FIG. 9: Chronoamperometry results of the copper printing. (A): Potential at the counter electrode; (B): Current measured during printing.

FIG. 10: Microscopy of the printed copper structures. (A): Scale bar—1000 μm; (B): Scale bar—1000 μm.

FIG. 11: Cyclic voltammetry plot for an example polypyrrole printing method.

FIG. 12: An image of a polypyrrole structure formed using the example polypyrrole printing method.

FIG. 13: Time lapse images of polypyrrole being deposited on ITO at: (A) 0 seconds; (b) 95 seconds; (C) 205 seconds; (D) 369 seconds; and (E) 410 seconds.

FIG. 14: Scanning electron micrographs of deposited polypyrrole structures at: (A) 200×; (B) 2000×; (C) 20,000×; (D) 630×; (E) 5480×; and (F) 15,500× magnification.

FIG. 15: Cyclic voltammetry plot for an example poly(3,4-ethylenedioxythiophene) (PEDOT) printing method.

FIG. 16: An image of a structure formed using the example PEDOT printing method.

FIG. 17: An image of a printed “ANU” structure formed using an example PEDOT printing method.

FIG. 18: Chronoamperometry plots for each letter structure formed using an example poly(3,4-ethylenedioxythiophene) (PEDOT) 3D printing method.

FIG. 19: Time lapse images of PEDOT being deposited on ITO to form a printed “A” structure at: (A) 0 seconds; (b) 15 seconds; (C) 44 seconds; (D) 115 seconds; and (E) 169 seconds.

FIG. 20: Scanning electron micrographs of deposited PEDOT structures at: (A) 791×; (B) 13,930×; and (C) 46,530× magnification.

FIG. 21: An image of a structure formed using an example polythiophene printing method.

FIG. 22: An image of a structure formed using an example polyaniline printing method.

FIG. 23: Time lapse images of polyvinylimidazole being deposited on ITO at: (A) 0 seconds; (b) 40 seconds; (C) 90 seconds; (D) 180 seconds; and (E) 207 seconds.

FIG. 24: An image of a structure formed using an example PEDOT and polyvinylimidazole printing method.

FIG. 25: Cyclic voltammetry plot for the example PEDOT and polyvinylimidazole printing method.

FIG. 26: Time lapse images of copper being deposited on ITO at: (A) 0 seconds; (b) 60 seconds; (C) 90 seconds; (D) 160 seconds; and (E) 200 seconds.

### DEFINITIONS

As used herein, the term “about”, is relative to the actual value stated, as will be appreciated by those of skill in the art, and allows for approximations, inaccuracies and limits of measurement under the relevant circumstances. Depending on context, it may allow a variation from the stated value of ±5%. In certain embodiments, it may allow a variation from the stated value of ±2%, ±1%, ±0.5%, ±0.2%, ±0.1%, ±0.05%, ±0.02%, or ±0.01%.

As used herein, the term “comprising” indicates the presence of the specified integer(s), but allows for the possibility of other integers, unspecified. This term does not imply any particular proportion of the specified integers. Variations of the word “comprising”, such as “comprise” and “comprises”, have correspondingly similar meanings.

As used herein, the term “precursor agent” means a material that is able to be oxidised or reduced resulting in the formation of a solid material when the electric potential difference is applied between the substrate and the electrode in the method described herein. In certain embodiments, the oxidised or reduced form of the precursor agent itself forms the solid material (or contributes to the mass of the solid material). In other embodiments, oxidisation or reduction of the precursor agent results in the formation of a solid material which does not comprise (or does not substantially comprise) the oxidised or reduced form of the precursor agent.

As used herein, the term “voltage pulses” means a regular series of bursts of voltage from zero to a maximum voltage, Vₘₐₓ. The waveform of a voltage pulse is typically in a sinusoidal or rectangular pulse pattern as distinct from a cyclic voltammetry voltage cycling. In certain embodiments the period between voltage pulses is less than 100 μs, 1 ms, 10 ms, or 100 ms.

As used herein, the phrase “measuring current between the substrate and the electrode” means to ascertain the rate of flow of electric charge between the substrate and the electrode.

As used herein, the term “chronoamperometry” means an electrochemical technique in which a potential is applied across a working and counter electrode, and the resulting current between the working and counter electrode is measured as a function of time. In certain embodiments, it means an electrochemical technique in which a potential is applied across a working and counter electrode and changed over time, and the resulting current between the working and counter electrode is measured as a function of time. In certain embodiments, the current is measured against a reference or pseudo-reference electrode (silver wire, Ag/AgCl). In certain embodiments, the same electrode is used both as a counter as a pseudo-reference electrode.

### Abbreviations

3D: Three-dimensional; AFM: atomic force microscope; AM: additive manufacturing; BA: n-butyl acrylate; [Bmim][BF4]: 1-butyl-3-methylimidazolium tetrafluoroborate; BPO: benzoyl peroxide; CAD: computer-aided design; CP: conductive polymer; [C4mim][CI]: 1-n-butyl-3-methylimidazolium chloride; CTA: chain transfer agent; CVD: chemical vapour deposition; e3DP: electro 3D printing/electro 3D printer; eATRP: electrochemical atom transfer radical polymerization; EBM: Electron Beam Melting; EDOT: 3,4-ethylenedioxythiophene; [Emim][Ntf2]: 1-ethyl-3-methylimidazolium bis(trifluoromethanesulfonyl)imide; FDM: fused deposition modeling; eRAFT: electrochemically mediated reversible addition—fragmentation chain-transfer polymerization; ICP: intrinsically conductive polymer; ITO: indium tin oxide; MMA: methyl methacrylate; PEDOT: poly(3,4-ethylenedioxythiophene); PEDOT:PSS: poly(3,4-ethylenedioxythiophene) polystyrene sulfonate; PVI: polyvinylimidazole; SEM: scanning electron microscopy; SLA: stereolithography; SLM: selective laser melting; tBA: tert-butyl acrylate; TBAHFP: tetrabutylammonium hexafluorophosphate; TPP: two photon 3D printing.

### DESCRIPTION OF EMBODIMENTS

Disclosed herein is a method for forming a multidimensional structure. The method comprises providing an electrode and a substrate in a fluid; wherein the fluid comprises an electrolyte, and a precursor agent dispersed therein; applying an electric potential difference between the substrate and the electrode to reduce or oxidise the precursor agent, thereby depositing a solid material; measuring current between the substrate and the electrode; and moving the electrode within the fluid to form a multidimensional structure of the solid material.

### Electrode

The electrode may be a microelectrode or nanoelectrode. The skilled person will understand that the size and geometry of the electrode may affect the geometry and resolution of the electrodeposited material formed during the printing process. The electrode may have any suitable shape, such as, for example, a disk, mesh, or comb. In certain embodiments the electrode may have a non-cylindrical shape. In other embodiments, the electrode may have a cylindrical shape, with an exposed area or tip available to be contacted with the fluid. The exposed area may be a disc-shaped area, or it may be a circular, or oval-shaped area. The exposed area may be substantially flat. The surface area of the electrode in contact with the fluid may be from about 10⁻⁹ m² to about 10⁻⁴ m², or it be from about 10⁻⁸ m² to about 10⁻⁴ m², about 10⁻⁷ m² to about 10⁴ m², about 10⁻⁶ m² to about 10⁻⁴ m², about 10⁻⁹ m² to about 10⁻⁵ m², about 10⁻⁹ m² to about 10⁻⁶ m², about 10⁻⁹ m² to about 10⁻⁷ m², or about 10⁻⁷ m² to about 10⁻⁵ m². It may be, for example, about 10⁻⁹, 10⁻⁸, 10⁻⁷, 10⁻⁶, 10⁻⁵, or 10⁻⁴ m².

The diameter of the electrode, across the surface exposed to the fluid, may be from about 1 nm to about 1000 μm, or it may be from about 100 nm to about 1000 μm, about 1 nm to about 500 μm, about 10 nm to about 1000 μm, about 20 nm to about 1000 μm, about 50 nm to about 1000 μm, about 200 nm to about 1000 μm, about 500 nm to about 1000 μm, about 1 μm to about 1000 μm, about 10 μm to about 1000 μm, about 100 nm to about 500 μm, about 100 nm to about 200 μm, about 100 nm to about 100 μm, about 100 nm to about 10 μm, about 200 nm to about 10 μm, about 500 nm to about 10 μm, or about 200 nm to about 400 μm. It may be, for example, about 1 nm, 2 nm, 5 nm, 10 nm, 20 nm, 50 nm, 100 nm, 200 nm, 500 nm, 1 μm, 2 μm, 5 μm, 10 μm, 20 μm, 50 μm, 100 μm, 200 μm, 500 μm, or 1000 μm.

The electrode may comprise a conductive material. For example, it may comprise one or more materials selected from the group consisting of platinum, carbon, gold, graphite, titanium, copper, zinc, silver, palladium, and mixed metal oxides. It may, for example, comprise platinum, carbon, or gold. The electrode may be coated with a non-electrically conductive material, such as glass, with a surface of the electrode being uncoated allowing it to be exposed to the fluid. In certain embodiments the electrode may be coated with a semi-permeable membrane.

### Substrate

The substrate may comprise a conductive material. It may itself act as an electrode, optionally a counter electrode or a working electrode. It may, for example, comprise indium tin oxide (ITO), silicon, aluminium, steel, gold, or a combination thereof. The skilled person will understand that the size and shape of the substrate may be suitable for the structure intended to be fabricated thereupon. In certain embodiments, the substrate may provide a substantially flat surface on which to print the structure.

The substrate may be positioned inside a container holding the fluid. It may be at the bottom of the container, or it may be at a point away from the bottom of the container. In certain embodiments the substrate may itself be a container able to hold the fluid.

### Fluid

The fluid comprises an electrolyte, and a precursor agent dispersed therein. In certain embodiments it may comprise an ionic liquid. The fluid may be in a container, and the electrode and substrate may be within the fluid in the container. The fluid may comprise one or more additional substances.

The fluid may comprise an aqueous solvent. It may comprise a polar aprotic solvent. In certain embodiments it may comprise an organic solvent. The organic solvent may comprise acetonitrile. In certain embodiments, the fluid does not comprise water.

### Container

The container may be a vat, or bath, which is capable of containing the fluid. The container may sit on the base of a 3D printer. The container may be of a suitable shape and size for fitting the multidimensional structure to be formed according to the method therein. The container may be of a suitable shape and size for the electrode to be able to move in three dimensions therein. In certain embodiments, the container itself is the substrate.

### Precursor Agent

The precursor agent is a material that is able to be oxidised or reduced resulting in the formation of a solid material when the electric potential difference is applied between the electrode and substrate. The precursor agent may itself form a solid material after being reduced or oxidised. Alternatively, or additionally, reduction or oxidation of the precursor agent may contribute to another material forming a solid.

In certain embodiments, oxidation or reduction of the precursor agent may modulate or catalyse a polymerisation reaction in the fluid. For example, oxidation or reduction of the precursor agent may modulate an electrochemical atom transfer radical polymerization (eATRP). eATRP is an electrochemically controlled version of atom transfer radical polymerization, during which the ratio of activator to deactivator catalyst is precisely controlled by an electrochemical redox process at an electrode surface. In copper-based eATRP, a desired amount of the catalytic complex (XCu^{Π}L), i.e. the precursor agent, can be electrochemically reduced to the active Cu^{I}L to trigger controlled radical polymerization of monomers (such as, for example: styrenes, (meth)acrylates, (meth)acrylamides, and acrylonitrile) (see Scheme 1 below), thereby rendering the eATRP process operational through an external stimulus.

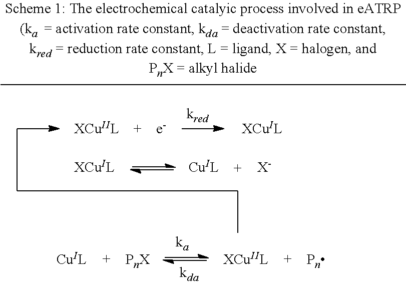

The process of eATRP can be affected through controlling the applied current, potential, and total charge passed, which may allow selection of the desired concentration of redox-active catalytic species. This may enhance the level of control during polymerization to form the solid material during the printing method. eATRP can be stopped and (re)initiated on demand by modulating the applied potential difference between the substrate and the electrode.

In certain embodiments, oxidation or reduction of the precursor agent may modulate or catalyse an electrochemically mediated reversible addition—fragmentation chain-transfer polymerization (eRAFT). eRAFT is another type of an electrochemical living polymerization based on degenerative transfer, which is mediated by chain transfer agents (CTAs) such as dithioesters, dithiocarbamates, trithiocarbonates, or xanthates.

The mechanism of eRAFT utilizing both compounds to generate radicals at ambient temperature is depicted in Scheme 2 below, while (meth)acrylates, (meth)acrylamides, acrylonitrile, styrene and derivatives, butadiene, vinyl acetate and N-vinylpyrrolidone (e.g. methyl methacrylate (MMA), n-butyl acrylate (BA), and tert-butyl acrylate (tBA)) can be used as monomers. Through controlling the R and Z groups of the (S═C(Z)S—R) CTA agent, i.e. the precursor agent, the reduction potential and therefore a predominant reduction mechanism during eRAFT can be controlled.

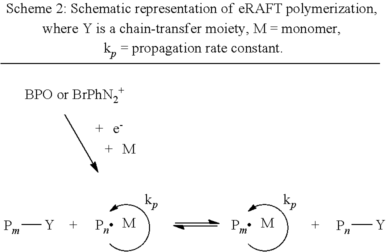

The availability of CTAs that can activate polymerization at different reduction potentials indicates that eRAFT may be an attractive method for e3DP and may lead to deposition of insulating films or microstructures according to the printing method described herein.

In certain embodiments, oxidation or reduction of the precursor agent may modulate or catalyse an electrochemically mediated ionic polymerization. Ionic polymerization may be initiated by the formation of a suitable initiator at the electrode interface for the polymerization of for example glycidyl ether, oxetane and vinyl ether based monomers.

In certain embodiments, oxidation or reduction of the precursor agent may modulate or catalyse an electrochemically mediated free radical polymerization. Free radical polymerization may be initiated by the formation of a suitable radical initiator at the electrode interface for the polymerization of, for example, (meth)acrylates, (meth)acrylamides, acrylonitrile, styrene and derivatives thereof, using, for example, butadiene, vinyl acetate, N-vinylpyrrolidone, methyl methacrylate (MMA), n-butyl acrylate (BA), and tert-butyl acrylate (tBA) as monomers for the polymerisation.

The precursor agent may be selected from the group consisting of salts (e.g. metal salts), metal ion complexes, ionic liquids, and monomeric materials. It may be selected from the group consisting of metal ion salts, metal ion complexes, ionic liquids, vinyl monomers, and monomers of conjugated polymers. In certain embodiments, the precursor agent may be a component of an ionic liquid. In certain embodiments, the precursor agent may also be the electrolyte. In certain embodiments, the precursor agent may, for example, be selected from the group consisting of GeI₄, ZnCl₂, InCl₃, SbCl₃, GaCl₃, AsCl₃, LiCl, LaCl₃, NbCl₅, FeCl₃, sodium molybdate, aniline, pyrrole, thiophene, 3,4-ethylenedioxythiophene, vinylimidazole, copper salts, and combinations thereof. In certain embodiments the precursor agent may be selected from the group consisting of metal salts and monomeric materials. In certain embodiments, it may, for example, be selected from the group consisting of aniline, pyrrole, thiophene, 3,4-ethylenedioxythiophene, vinylimidazole, and copper salts. In certain embodiments, it may, for example, be selected from the group consisting of acetylene, 3-alkylthiophenes, isothianaphthene, alkoxy-substituted p-phenylene vinylene, 2,5-bis(cholestanoxy) phenylene vinylene, 1,4-phenylene-1,2-diphenylvinylene, 3′,7′-dimethyloctyloxy phenylene vinylene, paraphenylene, heptadiyne, 3-hexylthiophene, 3-octylthiophene, 3-cyclohexylthiophene, 3-methyl-4-cyclohexylthiophene, 2,5-dialkoxy-1,4-phenyleneethynylene, 2-decyloxy-1,4-phenylene, quinolone, 9,9-dioctylfluorene, pyridine, p-phenylene-terephthalamide, and polyfluorene. In certain embodiments, the oxidation or reduction potential of the precursor agent may correspond to a voltage between the first and second voltages.

The concentration of the precursor agent in the fluid may be from about 10⁻⁵ M to about 1.5 M, or it may be from about 10⁻⁵ M to about 1 M, about 10⁻⁵ M to about 0.1 M, about 10⁻⁵M to about 10⁻² M, about 10⁻⁵ M to about 10⁻³ M, about 10⁻⁴ M to about 1.5 M, about 10⁻³ M to about 1.5 M, or about 10⁻³M to about 0.1 M. It may be, for example, about 10⁻⁵, 10⁻⁴, 10⁻³, 10⁻², 0.1, 0.2, 0.5, 1, or 1.5 M.

### Electrolyte

The electrolyte may be an ionic species which increases the conductivity of the fluid. The electrolyte may be an inorganic or organic salt. It may, for example, be an alkali metal salt, an organic electrolyte, or an ionic liquid. It may, for example, be selected from the group consisting of sodium perchlorate, potassium chloride, lithium bis(trifluoromethanesulfonyl)imide, N,N-Diethyl-N-methylethanaminium tetrafluoroborate, Bu₄NBF₄, [Bmim][BF₄], [Emim][Ntf₂], and [C₄mim][Cl]. It may, for example, comprise tetrabutylammonium hexafluorophosphate. In certain embodiments, the electrolyte may act as both a solvent and an electrolyte. That is, in certain embodiments, the electrolyte and solvent may be one and the same material.

The concentration of the electrolyte in the fluid may be from about 10⁻⁵M to about 1.5 M, or it may be from about 10⁻⁵ M to about 1 M, about 10⁻⁵M to about 0.1 M, about 10⁻⁵M to about 10⁻²M, about 10⁻⁵M to about 10⁻³M, about 10⁻⁴ M to about 1.5 M, about 10⁻³M to about 1.5 M, or about 10⁻³M to about 0.1 M. It may be, for example, about 10⁻⁵, 10⁻⁴, 10⁻³, 10⁻², 0.1, 0.2, 0.5, 1, or 1.5 M.

### Printing Method

The method disclosed herein is a method for forming, or printing a multidimensional structure. It comprises providing an electrode and a substrate in a fluid; wherein the fluid comprises an electrolyte, and a precursor agent dispersed therein; applying an electric potential difference between the substrate and the electrode to reduce or oxidise the precursor agent, thereby depositing a solid material; measuring current between the substrate and the electrode; and moving the electrode within the fluid to form a multidimensional structure of the solid material.

The electrode may be moved using the motors within a 3D printer, that enable movement of an electrode holder in the x, y, and z direction. The electrode positioning precision may be determined by the precision of motors used in the system, with ˜10 μm in the case of stepper motor-driven system and potentially precision of down to 10 nm for a piezoelectric motor-driven device. The electric field generated through the process may be determined by the size and material of the electrode used, substrate material, fluid conductivity, potential applied, and the distance between the electrode and the substrate.

The current between the substrate and the electrode may be measured at a plurality of time points. The time points may be from about 1 μs to about 10 seconds apart, or they may be from about 100 μs to about 1 second, about 1 ms to about 1 second, or about 0.1 second to about 1 second apart. They may be, for example, about 1 μs, 2, μs, 5, μs, 10, μs, 20 μs, 50 μs, 100 μs, 200 μs, 500 μs, 1 ms, 2 ms, 5 ms, 10 ms, 20 ms, 50 ms, 0.1 sec, 0.2 sec, 0.5 sec, 1 sec, 2 sec, 5 sec, or 10 seconds apart.

In certain embodiments the current between the substrate and the electrode is measured as a function of time.

The method may further comprise varying one or more of the electrical potential difference between the substrate and the electrode, and the position of the electrode when the current is above, below, or at a predetermined value. In certain embodiments the method comprises increasing the electric potential difference between the substrate and the electrode, and/or decreasing the distance between the electrode and the substrate or multidimensional structure, when the current is below the predetermined value.

The method may further comprise adjusting the electrical potential from a first voltage to a second voltage. The time for adjusting the electrical potential from the first voltage to the second voltage may be 100 μs or more, or it may be 200 μs or more, 500 μs or more, 1 ms or more, 2 ms or more, 2 ms or more, 5 ms or more, 10 ms or more, 20 ms or more, 50 ms or more, 100 ms or more, 200 ms or more, 500 ms or more, 1 s or more, 10 s or more, or 1 minute or more. It may be from about 100 μs to about 5 hours, or from about 200 μs to about 10 sec, about 500 μs to about 10 sec, about 1 ms to about 10 sec, about 2 ms to about 5 sec, about 5 ms to about 5 sec, about 10 ms to about 5 sec, about 20 ms to about 5 sec, about 10 ms to about 5 sec, about 50 ms to about 5 sec, about 100 ms to about 5 sec, about 200 ms to about 5 sec, or about 500 ms to about 5 sec. It may be, for example, about 100 μs, 200 μs, 500 μs, 1 ms, 2 ms, 5 ms, 10 ms, 20 ms, 50 ms, 100 ms, 200 ms, 500 ms, 1 sec, 2 sec, 5 sec, 10 sec, 20 sec, 1 min, 2 min, 5 min, 10 min, 20 min, 30 min, 1 hour, 2 hours, or 5 hours.

In certain embodiments, the method comprises cycling the electrical potential between the first voltage and the second voltage. The cycling in the method may comprise varying the electrical potential difference from the first voltage to the second voltage and back to the first voltage, wherein the absolute average rate of change in electric potential difference when varying the electric potential difference from the first voltage to the second voltage is substantially the same as when varying the electric potential difference from the second voltage back to the first voltage.

The cycling in the method may comprise varying the electrical potential difference by starting at a first voltage, and ramping the voltage over a period of time to a second voltage, and then ramping the voltage back down to the first voltage, and repeating the cycle. In certain embodiments, the cycling does not comprise voltage pulses. In certain embodiments, the cycling comprises voltage pulses.

The inventors of the presently claimed invention have surprisingly discovered that by applying a voltage between the substrate and the electrode to reduce or oxidise the precursor agent, thereby depositing a solid material; and measuring current between the substrate and the electrode, i.e. using chronoamperometry, when printing, it is possible to monitor the deposition of the solid material in situ. That, is, the current vs time plot shows that with increasing current, in linear current regions when the reaction is in a steady state, more material has been deposited, thereby providing an indication of the quality of the printed structure, and enabling the electrode to be moved to a new position for further deposition.

The time for one cycle from the first voltage to the second voltage and back to the first voltage may be 100 μs or more, or it may be 200 μs or more, 500 μs or more, 1 ms or more, 2 ms or more, 2 ms or more, 5 ms or more, 10 ms or more, 20 ms or more, 50 ms or more, 100 ms or more, 200 ms or more, 500 ms or more, or 1 s or more. It may be from about 100 μs to about 20 sec, or from about 200 μs to about 10 sec, about 500 μs to about 10 sec, about 1 ms to about 10 sec, about 2 ms to about 5 sec, about 5 ms to about 5 sec, about 10 ms to about 5 sec, about 20 ms to about 5 sec, about 10 ms to about 5 sec, about 50 ms to about 5 sec, about 100 ms to about 5 sec, about 200 ms to about 5 sec, or about 500 ms to about 5 sec. It may be, for example, about 100 μs, 200 μs, 500 μs, 1 ms, 2 ms, 5 ms, 10 ms, 20 ms, 50 ms, 100 ms, 200 ms, 500 ms, 1 sec, 2 sec, 5 sec, or 10 sec.

The starting distance between the electrode tip and the substrate may be from about 10 nm to about 1000 μm, or it may be from about 10 nm to about 500 μm, about 10 nm to about 100 μm, about 20 nm to about 1000 μm, about 50 nm to about 1000 μm, about 100 nm to about 1000 μm, about 200 nm to about 500 μm, about 1 μm to about 500 μm, about 5 μm to about 500 μm, about 5 μm to about 100 μm, about 10 μm to about 1000 μm, about 20 μm to about 1000 μm, about 50 μm to about 1000 μm, or about 10 μm to about 500 μm. It may be, for example, about 10 nm, 20 nm, 50 nm, 100 nm, 200 nm, 500 nm, 1 μm, 2 μm, 5 μm, 10 μm, 15 μm, 20 μm, 25 μm, 30 μm, 50 μm, 60 μm, 70 μm, 80 μm, 90 μm, 100 μm, 110 μm, 120 μm, 150 μm, 200 μm, 300 μm, 400 μm, 500, 600, 700, 800, 900, or 1000 μm.

The distance between the electrode tip and the structure during printing may be from about 10 nm to about 1000 μm, or it may be from about 10 nm to about 500 μm, about 10 nm to about 100 μm, about 20 nm to about 1000 μm, about 50 nm to about 1000 μm, about 100 nm to about 1000 μm, about 200 nm to about 500 μm, about 1 μm to about 500 μm, about 5 μm to about 500 μm, about 5 μm to about 100 μm, about 10 μm to about 1000 μm, about 20 μm to about 1000 μm, about 50 μm to about 1000 μm, or about 10 μm to about 500 μm. It may be, for example, about 10 nm, 20 nm, 50 nm, 100 nm, 200 nm, 500 nm, 1 μm, 2 μm, 5 μm, 10 μm, 15 μm, 20 μm, 25 μm, 30 μm, 50 μm, 60 μm, 70 μm, 80 μm, 90 μm, 100 μm, 110 μm, 120 μm, 150 μm, 200 μm, 300 μm, 400 μm, 500, 600, 700, 800, 900, or 1000 μm.

The method may further comprise a step of measuring the current between the electrode and substrate; and if the current is above, below, or at a predetermined value, varying one or more of the electrical potential difference between the substrate and the electrode, the current between the substrate and the electrode, and the position of the electrode. In certain embodiments the current may be measured as a function of time (i.e. using chronoamperometry). In certain embodiments the current may be measured as a function of voltage (i.e. cyclic voltammetry). In general, the current and charge measured between the electrodes during a chemical reaction occurring during the printing process is proportional to the amount of the deposited material (as per 1st Faraday's law). Accordingly, for example, a sudden decrease in measured charge during a chronoamperometric measurement while printing may signify a defect in the print, and as a result the electrode could be moved to the spot of the current “minimum” again to re-print the defective part of the structure in certain embodiments.

In certain embodiments, the method comprises using a three electrode setup (working, counter and reference electrodes) thereby enabling comparison of the potential between the working and the counter electrode by having, for example, an Ag/AgCl reference that remains inert during the printing. This allows us to measure not just the potential of the system, but the potential at the counter electrode. In such a setup, the substrate may act as the counter electrode, and the electrode as described herein may act as the working electrode. Alternatively, the substrate may act as the working electrode, and the electrode as described herein may act as the counter electrode.

In certain embodiments, the method further comprises a negative control measurement (e.g. a measurement of the electrolyte in the fluid without the precursor agent) which can used to subtract the effect of the electrode movement and/or the electrolyte/solvent contribution in the electrochemical analysis. In other words, measuring the current response without the precursor agents prior to the actual printing so as to form a “negative control baseline” to be subtracted from the electrochemical measurements performed during the printing process.

In certain embodiments, the method further comprises using a computer and software to control the printing process, whereby the software provides instructions to the 3D printer to adjust the voltage, current or electrode position in response to a change in the current-time or current-voltage measurement.

In certain embodiments there is provided a method for forming a multidimensional structure, the method comprising the following steps:

providing an electrode and a substrate in a fluid,
wherein the fluid comprises:
   TBAHFP, and
   pyrrole in acetonitrile;

applying an electric potential difference between the substrate and the electrode to oxidise the pyrrole, thereby depositing polypyrrole;

measuring current between the substrate and the electrode; and

moving the electrode within the fluid to form a multidimensional structure of the polypyrrole;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   EDOT in acetonitrile;

applying an electric potential difference between the substrate and the electrode to oxidise the EDOT, thereby depositing PEDOT;

measuring current between the substrate and the electrode; and

moving the electrode within the fluid to form a multidimensional structure of the PEDOT;

wherein the current between the substrate and the electrode is measured as a function of time;
and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   thiophene in acetonitrile;

applying an electric potential difference between the substrate and the electrode to oxidise the thiophene, thereby depositing polythiophene;

measuring current between the substrate and the electrode; and

moving the electrode within the fluid to form a multidimensional structure of the polythiophene;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   aniline in acetonitrile;

applying an electric potential difference between the substrate and the electrode to oxidise the aniline, thereby depositing polyaniline;

measuring current between the substrate and the electrode; and

moving the electrode within the fluid to form a multidimensional structure of the polyaniline;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   vinylimidazole in acetonitrile;

applying an electric potential difference between the substrate and the electrode to oxidise the vinylimidazole, thereby depositing polyvinylimidazole;

measuring current between the substrate and the electrode; and

moving the electrode within the fluid to form a multidimensional structure of the polyvinylimidazole;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP, and
   Cu²⁺ in acetonitrile;

applying an electric potential difference between the substrate and the electrode to reduce the Cu²⁺, thereby depositing copper;

measuring current between the substrate and the electrode; and

moving the electrode within the fluid to form a multidimensional structure of the copper;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

### Solid Material

The solid material may be a semiconductor, polymer or a metal, including mixtures and/or alloys thereof. It may be an organometallic material. It may comprise, for example, one or more selected from the group consisting of metal organic frameworks (MOFs), biomaterials, vinyl polymers, chemical patterns, ceramics, and colloidal particles. In certain embodiments the solid material may be an elemental semiconductor, binary semiconductor, or semiconductor nanoparticles. In certain embodiments the solid material is selected from the group consisting of vinyl polymers, conjugated polymers, metals, and combinations thereof. In certain embodiments it may be a metal alloy. In certain embodiments it may be selected from the group consisting of aluminium, indium, antimony, copper, silver, tellurium, cadmium, palladium, gold, zinc, tin, gallium, iron, nickel, cobalt, sodium lithium, and alloys thereof. In certain embodiments it may be selected from MoS₂, zinc telluride, germanium, and indium antimonide. In certain embodiments, it may, for example, be selected from the group consisting of Si, Ge, CdTe, CdSe, CdS, ZnSe, ZnTe, GaAs, GaP, In(P,As or Sb), In₂S₃, PbS, CdTe, CdSe, ZnTe, (Cd,Zn)S, (Cd,Zn)Te, CdS, CuInSe₂, molybdenum ((IV) and/or (VI)) oxide, and (Cd,Hg)Te). In certain embodiments it may be selected from the group consisting of polypyrrole, poly(3,4-ethylenedioxythiophene), polythiophene, polyaniline, poly(3,4-ethylenedioxythiophene) polystyrene sulfonate (PEDOT:PSS), polypyrrole:dopamine copolymer, polyvinylimidazole, and copper. In certain embodiments, it may be parylene, PEDOT, epoxy or polyimide. In certain embodiments, it may be a biomolecule, such as a biopolymer (e.g. a protein). The skilled person will understand that the method disclosed herein may be adapted to produce multidimensional structures made from a variety of different solid materials.

In certain embodiments, the solid material may comprise soft condensed matter.

### Multi-Material Printing

The method disclosed herein may be used to form structures comprising more than one type of solid material. The method may, for example comprise using a first precursor agent in a first fluid, and a second precursor agent in a second fluid, and printing a first solid material from the first fluid, before exchanging the first fluid for the second fluid, and subsequently printing a second solid material from the second fluid.

In certain embodiments, the fluid is a first fluid, and the method disclosed herein further comprises:

replacing the first fluid with a second fluid, wherein the second fluid comprises:
an electrolyte, and
a precursor agent dispersed therein, wherein the precursor agent of the second fluid is different to the precursor agent of the first fluid; and

applying an electrical potential difference between the electrode and the substrate to reduce or oxidise the precursor agent of the second fluid, thereby depositing a second solid material.

Alternatively, or additionally, the method may comprise printing a first and second solid material from a single fluid, using the respective oxidation/reduction potentials for a first and second precursor agent to selectively deposit the first and second solid material.

In certain embodiments, the fluid comprises a first precursor agent and a second precursor agent, and the method disclosed herein further comprises:
applying a first electrical potential difference between the electrode and the substrate to reduce or oxidise the first precursor agent, thereby depositing a first solid material; and
applying a second electrical potential difference between the electrode and the substrate to reduce or oxidise the second precursor agent, thereby depositing a second solid material.

In certain embodiments, the first precursor agent is EDOT, the first solid material is PEDOT, the second precursor agent is vinylimidazole, and the second solid material is polyvinylimidazole.

In certain embodiments there is provided a method for forming a multidimensional structure, the method comprising the following steps:

providing an electrode and a substrate in a fluid,
wherein the fluid comprises:
   TBAHFP,
   EDOT, and
   Cu²⁺;

applying a first electric potential difference between the substrate and the electrode to oxidise the EDOT, thereby depositing PEDOT;

applying a second electrical potential difference between the substrate and the electrode to reduce the Cu²⁺, thereby depositing copper;

measuring current between the substrate and the electrode; and

moving the electrode within the fluid to form a multidimensional structure of the PEDOT and copper;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

In certain embodiments there is provided a method for forming a multidimensional structure, the method comprising the following steps:

providing an electrode and a substrate in a fluid,
wherein the fluid comprises:
   TBAHFP,
   EDOT, and
   vinylimidazole in acetonitrile;

applying a first electric potential difference between the substrate and the electrode to oxidise the EDOT, thereby depositing PEDOT;

applying a second electrical potential difference between the substrate and the electrode to oxidise the vinylimidazole, thereby depositing polyvinylimidazole;

measuring current between the substrate and the electrode; and

moving the electrode within the fluid to form a multidimensional structure of the PEDOT and polyvinylimidazole;

wherein the current between the substrate and the electrode is measured as a function of time; and the method further comprises increasing the electric potential difference between the substrate and the electrode, and/or decreasing a distance between the electrode and the substrate or multidimensional structure, when the current is below a predetermined value.

### Surface Modification

In certain embodiments, the method disclosed herein further comprises a step of oxidising or reducing a surface of the deposited solid material and/or a surface of the substrate thereby forming a reactive surface; and reacting a surface reactive agent with the reactive surface, thereby forming a modified surface of said deposited solid material and/or said substrate.

The surface reacting agent may be a compound capable of reacting and binding to the reactive surface. The surface reactive agent may be a biomolecule, or a linker capable of binding a biomolecule.

In certain embodiments, a surface of the deposited solid material and/or substrate may be pre-functionalised by attaching an oxidizable or reducible agent to said surface, which may be oxidized or reduced to form the reactive surface.

The biomolecule may be a protein. It may be a biomarker. It may be, for example, an enzyme, or an antibody.

### Etching

In certain embodiments, the method disclosed herein further comprises a step of etching the substrate. The etching may be an electrochemical etching.

In certain embodiments, the deposited solid material may form a mask which protects a portion of the substrate during the etching process, thereby allowing selective etching of the non-protected portion of said substrate. In certain embodiments, the substrate may be stainless steel, copper or aluminium and the deposited solid material may be parylene, PEDOT, epoxy or polyimide.

In certain embodiments, the deposited solid material may be removed after the etching. It may be removed by dissolving said deposited solid material. In certain embodiments, it may be removed by oxidizing or reducing the deposited solid material, before dissolving the resultant oxidized or reduced material.

### Device

Disclosed herein is a device for producing a multidimensional structure. The device comprises an electrode, a container, one or more motors, a substrate and a potentiostat. The container is for holding a fluid. The one or more motors are for moving the electrode within the container. The substrate is within the container. The potentiostat is for applying an electric potential difference between the substrate and the electrode and for measuring current between the substrate and the electrode.

As discussed above, the container is for holding a fluid. The container and/or fluid may be as hereinbefore described with respect to the method.

The electrode and/or substrate of the device may be as hereinbefore described with respect to the method.

The device may further comprise a reference electrode in electrical connection to the potentiostat.

The device may further comprise a quartz crystal microbalance (QCM) for measuring the mass of the multidimensional structure.

As described above, the one or more motors are for moving the electrode within the container. In certain embodiments, the device comprises three motors.

In certain embodiments, the device is a 3D printer.

In certain embodiments, the device is a part of a system, wherein the system also comprises a controller which is capable of controlling the printing parameters for the device (e.g. the distance between the electrode and substrate and/or multidimensional structure, and/or the potential difference between the substrate and the electrode) based on the current measured between the substrate and the electrode. Precise electrochemical measurements and feedbacked control of the printing parameters may allow for in situ quality control during printing and ensure reproducible printing.

### Multidimensional Structure

Disclosed herein is a multidimensional structure which is formed using the method described hereinbefore. The multidimensional structure may be a two- or three-dimensional structure. In certain embodiments it may be a three-dimensional structure. It may be electrically conductive. It may be electrically insulating. It may comprise regions of electrical conductivity and regions of non-conductivity.

In certain embodiments the multidimensional structure may be a composite structure. That is, it may comprise two or more different materials. For example, it may comprise PEDOT and copper.

### Printer

Disclosed herein is a printer when used to print a multidimensional structure according to the method disclosed hereinbefore. The printer may be a 3D printer. The printer may comprise a container for containing the fluid described hereinbefore. The printer may comprise an electrode as hereinbefore described. The electrode may be configured to be moveable along an x, y and z axis of the printer. The electrode may be positionable within the container.

### EXAMPLES

The present invention will now be further described in greater detail with reference to the following specific examples, which should not be construed as in any way limiting the scope of the invention.

### Materials

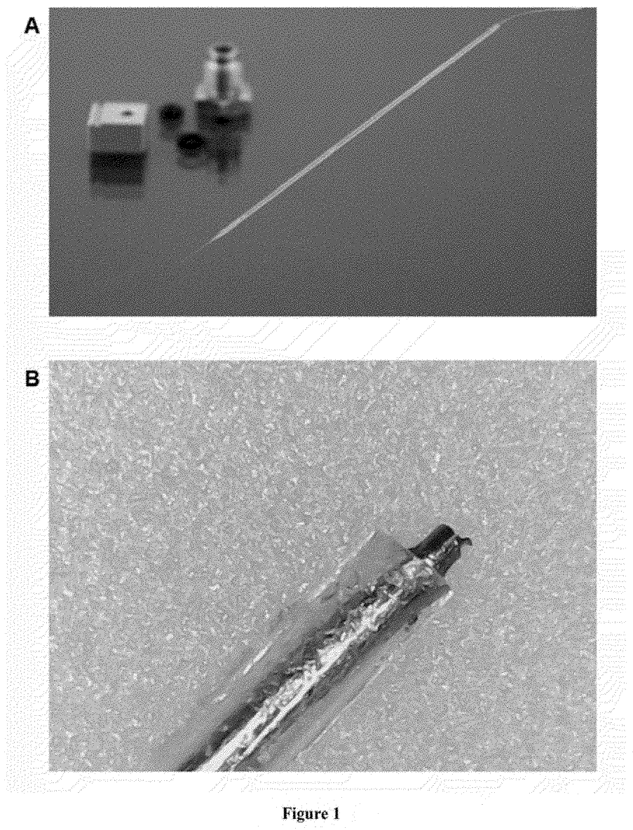

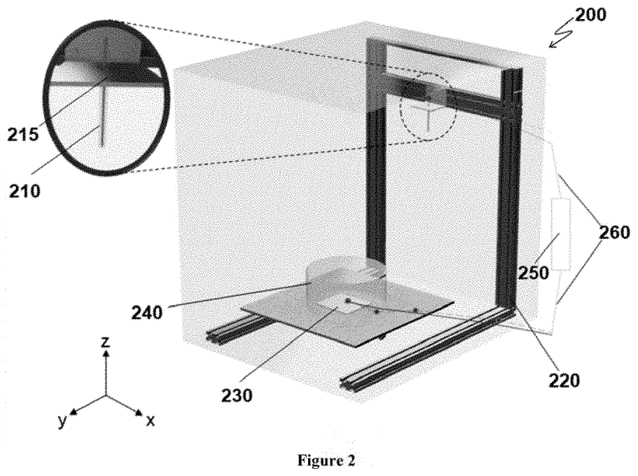

3,4-ethylenedioxythiophene (EDOT), pyrrole, aniline, tetrabutylammonium hexafluorophosphate (TBAHFP) and sulfuric acid were purchased from Sigma-Aldrich (Castle Hill, Australia), and used without further purification. Copper (II) sulfate was purchased from Acros Scientific. EDOT and TBAHFP were dissolved in acetonitrile in concentrations of 70 mM and 97 mM respectively. A 1.28 M saturated copper (II) sulfate solution was prepared by dissolving copper (II) sulfate and concentrated sulfuric acid (0.94 M) in acetonitrile and stirring the solution overnight. For the single bath multi-material printing of EDOT:CuSO₄, the previously prepared EDOT and copper (II) sulfate solutions were mixed in 1:1 volume ratio. ITO-covered glass substrates were prepared through sonication in acetone, isopropanol and deionised water for 5 minutes each, with subsequent drying under a stream of nitrogen. ITO-covered flexible PET substrates were provided with a co-extruded protective layer, which was removed directly before printing. Platinum microelectrodes were prepared by sealing a platinum wire with a 300 μm diameter in a glass capillary and sealing the tip with a two-component epoxy glue. The microelectrode tip was cut and cleaned with aqua regia and deionised water before each printing experiment. Electrodes used typically had a surface area in the 10⁻⁴ to 10⁻⁹ m² range. Example electrodes are shown in FIG. 1. FIG. 1(A) is an image of a nanoelectrode having a diameter of 217 nm. FIG. 1(B) is an image of a microelectrode having a diameter of 370 μm. A chlorinated silver wire (Ag/AgCl) was used as a pseudo-reference electrode to control the cell potential.

### Example 1: Electrochemical 3D Printer

A commercial FDM 3D printer was converted into an electrochemical 3D printer. FIG. 2 presents a schematic of the electrochemical 3D printer 200. A three electrode setup was used in which a platinum microelectrode 210 and a Ag/AgCl reference electrode (not shown) is attached to a holder 215 in alignment with the Z axis of the printer, while the substrate 230 is immersed in a liquid bath in container 240, which is filled with an electrolyte and a precursor agent, such as EDOT, pyrrole, CuSO₄ solution or mixed EDOT:CuSO₄ in solution. The microelectrode 210, conductive substrate 230, and reference electrode were attached to a potentiostat 250 via wires 260, as a working electrode, counter electrode and reference electrode, respectively, unless stated otherwise. During a printing experiment, the applied potential (in respect to the reference electrode) and the current were measured in order to control the rate of the deposition, the quantity of the deposited material and to detect precursor depletion. The unit has two movements (X and Y axis) and the microelectrode holder is able to move along Z axis along rail 220. In use formation of the deposited structures were controlled through manually written Gcode, which determined the XYZ movement of the printer, controlled by stepper motors (not shown). The printer was controlled with an open source pronterface software.

### Electrochemical Deposition to Fabricate 3D Polymer or Metallic Structures, and In-Situ Measurements

For the deposition, the container 240 was filled with the electrolyte and precursor agent solution. Firstly, the printer was levelled by measuring the resistance between the substrate 230 and the electrode 210 with a multimeter. The printing was carried out potentiostatically at positive oxidation potentials in the case of monomeric precursor agents (for example, EDOT at Eₒₓ=5.7 V and pyrrole at Eₒₓ=2.9 V) and at negative reduction potentials in the case of metal ion precursor agents (for example, E_{red}=−4.2 V in case of a copper salt precursor agent). For multimaterial printing first a metal salt was deposited at a negative potential, and then polymer was printed simply by reversing the direction of the current and increasing it for EDOT; or decreasing it for pyrrole to the respective Eₒₓ.

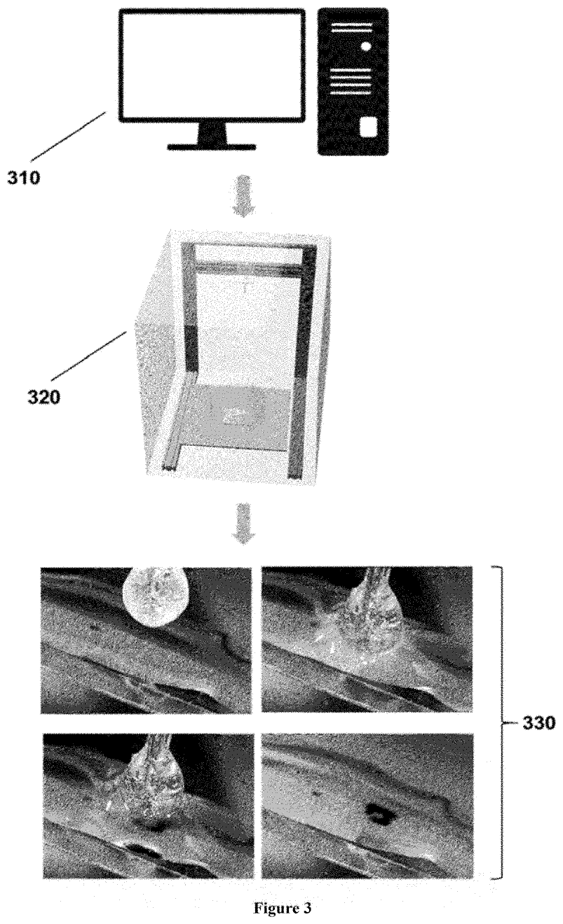

An example fabrication process is shown in schematic form in FIG. 3. A computer 310 was used to control the 3D printer 320 to fabricate the 3D or 2D structures, whose formation was monitored using a microscope camera to produce images of the deposition 330. A user can utilise the computer 310 to design a 3D object to be fabricated. The relevant materials are then loaded into the container of the 3D printer 320, and the instruction code sent from the computer 310 to the 3D printer 320. The 3D printer 320 then proceeds to fabricate the 3D object using the relevant materials in the container. The fabrication can be monitored using a microscope camera to produce images of the deposition 330.

### Example 2: A Device for Producing a Multidimensional Structure

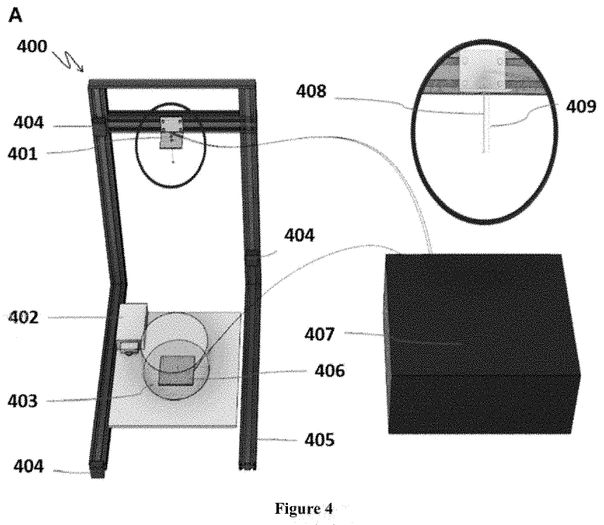

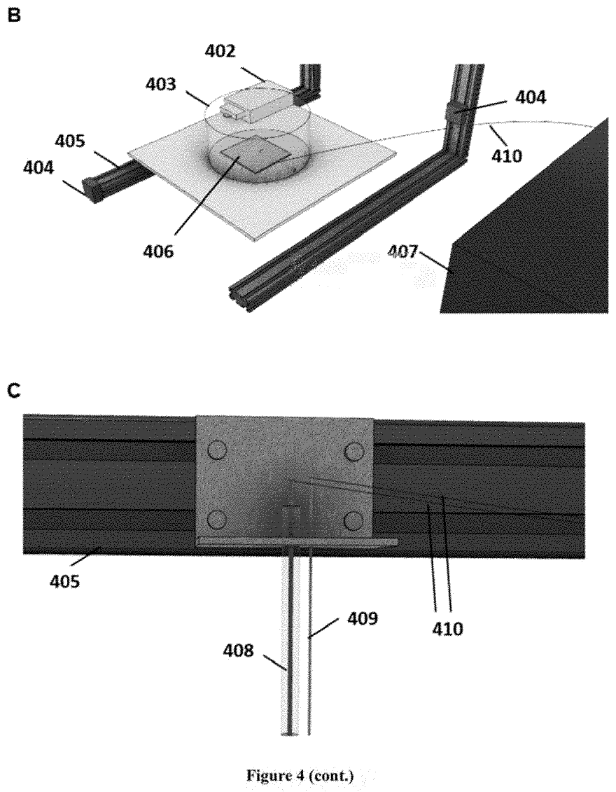

An example device for producing a multidimensional structure is shown in FIG. 4. The device 400 comprises a moveable electrode holder 401, quartz crystal microbalance 402, precursor container 403, stepper motors 404, rail 405, substrate 406, potentiostat 407, working electrode 408, reference electrode 409 and wires 410. The potentiostat 407 is connected to the working electrode 408, reference electrode 409, and substrate 406 via wires 410. The three stepper motors 404 enable movement of the electrode holder 401 in three dimensions.

In use, a fluid comprising an electrolyte and a precursor agent dispersed therein is added to the container 403 of the device 400. The working electrode is positioned so that it is within the fluid and close to the substrate 406. A potential difference is applied between the substrate 406 and the working electrode 408 using the potentiostat, so as to reduce or oxidise the precursor agent, thereby depositing a solid material. The current between the substrate 406 and the working electrode 408 is measured using the potentiostat 407 and can be used to optimise the printing parameters in situ during the printing process. The working electrode is moved within the fluid to form a multidimensional structure of the solid material. The quartz crystal microbalance 402 is used to measure the mass of the growing multidimensional structure during printing.

### Example Printing Processes

All experiments were performed in a grounded Faraday cage, using a multi-channel PalmSens potentiostat (Palm Instruments BV, The Netherlands) interfaced with a laptop. The printing procedure was controlled by the Palm Sens PC software. For the majority of the prints simple chronoamperometry or multi-step chronoamperometry was used with a three-electrode cell configuration. Before the print the printer was calibrated by lowering the working electrode until it touched the substrate and the measured potential was 0V.

### Example 3: PEDOT Pillar Print

Electropolymerisation of EDOT was conducted via simple chronoamperometry or multi-step chronoamperometry in the potential range between 3.5 V and 6.5 V. During the experiment cell current (I) and the cell potential (E_{cell}) were measured every 0.1 to 0.5 seconds. In order to determine the mass deposited during printing, a baseline measurement with just a solvent and the electrolyte salt was performed with the same parameters as a print was. This baseline (negative control) was subtracted from the current (I) vs time or charge (Q) vs time plots.

The mass of polymer deposit (m) was calculated by applying Faraday's law, assuming a 100% faradic efficiency using the following equation:

$$m = \frac{Q \cdot {M}_{w}}{n \cdot F} = \frac{I \cdot t \cdot {M}_{ω}}{n \cdot F}$$

Where t is the time of the print in seconds, M_{w} is the molecular weight EDOT (142.18 g/mol), F is the Faraday constant (96 485 C/mol), and n is the number of electrons transferred during the polymerization.

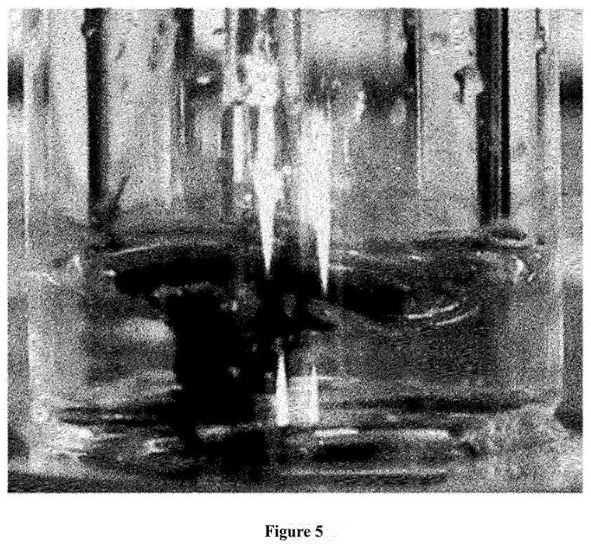

In order to demonstrate the printing procedure, three simple example PEDOT pillar prints were performed. A glass ring with a 28.26 mm² surface area was placed on top of a gold substrate and filled with the EDOT solution (or electrolyte solution for the blank measurements). The same solution was used for all three printing and blank experiments, respectively. During the printing process the platinum electrode was moved from a starting microelectrode-substrate distance of d₀=100 μm upwards with a speed of 0.1 mm/s until a distance of 1.00 mm from the substrate was reached. In this experiment, a gold-coated quartz substrate was used as a working electrode, and a platinum microelectrode was used as a counter and pseudo-reference electrode. A constant potential of 3.5 V was applied, and the current was measured every 0.1 seconds. The resulting printed structure can be seen as a black pillar formed underneath the microelectrode in FIG. 5.

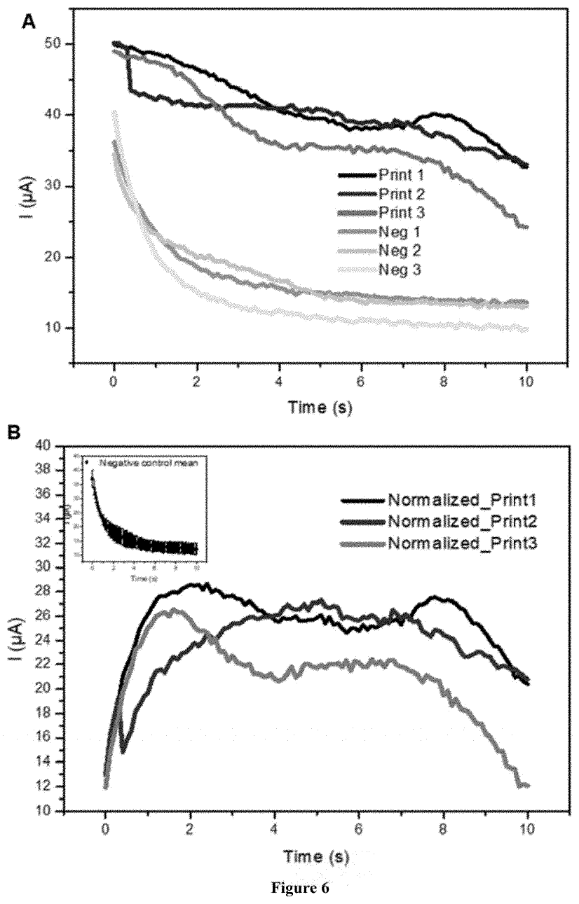

The current plots of the three prints in the presence of the EDOT monomer (Print 1, 2, 3) alongside three prints in the absence of the monomer (Neg 1, 2, 3) are shown in FIG. 6(A). During printing the top curves of FIG. 6A were measured, which suggested that the current was decreasing throughout the whole printing process. However, after a baseline subtraction was performed, the normalized current curves were acquired (shown in FIG. 6B). The normalized plots show that for all three prints the current was actually increasing in the first two seconds, presumably due to the narrow starting distance limiting the initial reaction. The initial increase was followed by either two peaks (Print 1 and 3) or one (Print 2) and a subsequent decrease as a result of either or both lower monomer availability or lower electric field strength resulting from the 1.00 mm distance between the electrodes. The overall current decreasing chronologically between the prints may have been due to monomer depletion from the printing solution due to successive printing from the same solution.

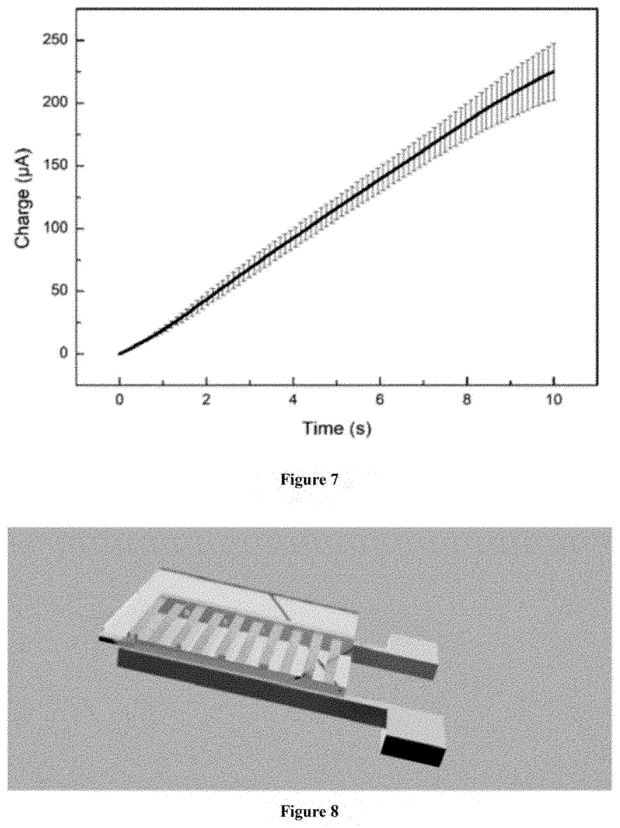

An average charge curve for all three prints, calculated from the integral of the normalized current curves in FIG. 6B can be seen in FIG. 7. The standard deviation of the charge curve increased with both the distance from the substrate and printing time, which was probably due to monomer depletion from the printing solution. If the charge curve is linearly fitted and a linear relation between the deposited mass and charge is assumed (i.e. 100% faradic efficiency), it is possible to calculate the theoretical polymer mass, using the equation shown above. It is also possible to acquire the rate of mass deposition from the fit's slope. This information can be used to adjust the printing parameters ‘on-the-fly’, e.g. by increasing the E_{cell} or lowering the electrode to reduce the electrode-substrate or electrode-structure distance when the rate of deposition is decreasing.

### Example 4: Copper Circuit Print

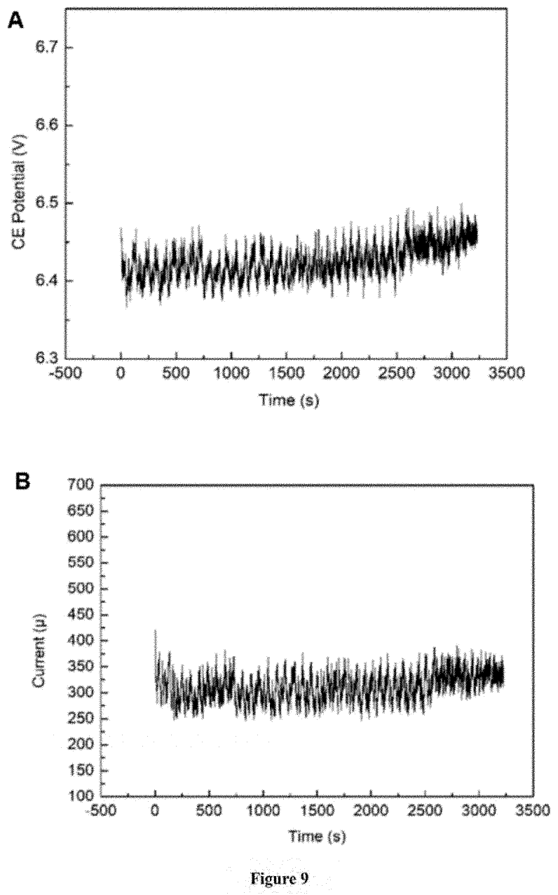

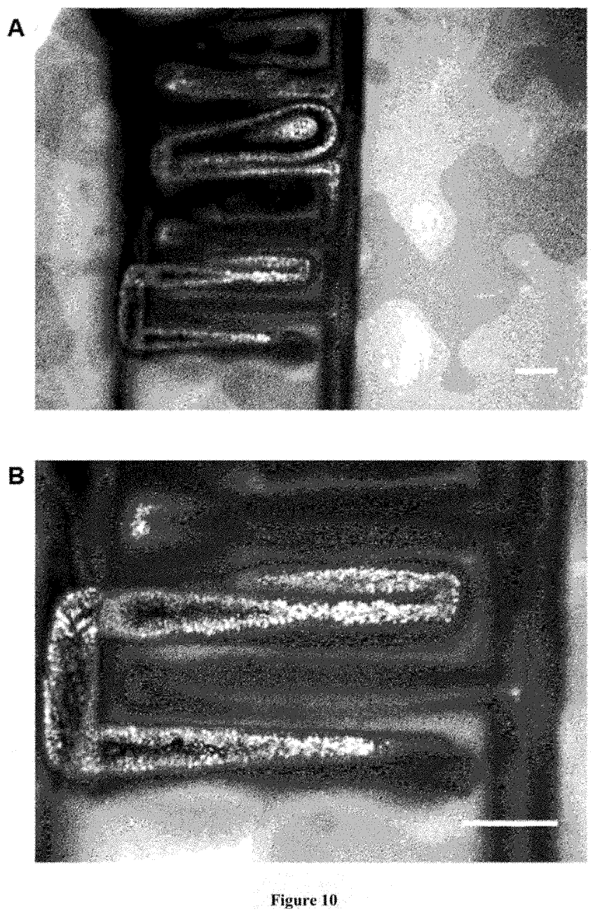

Copper interdigitated structures were printed using a three-electrode set up, with a platinum microelectrode as a working electrode, ITO covered PET plastic substrate as a counter electrode and chlorinated silver wire as an Ag/AgCl pseudo-reference electrode. Throughout the print the platinum electrode was moved from a starting microelectrode-substrate distance of do=400 μm. The CAD render of the printed structure can be seen in FIG. 8 (bottom layer). The structure was printed by loading a GCode into the printer and moving the electrode layer-by-layer at a speed of 6 mm/s and a layer thickness of 50 μm. A potentiostatic chronoamperometry measurement was performed to reduce the copper from Cu²⁺ to Cu⁰, during which the potential of 6.0 V between the working and the counter electrode was controlled with a pseudo-reference electrode. The applied counter electrode potential necessary to maintain the cell potential was measured and adjusted. The current of the deposition was measured every 0.2 seconds. The resulting printed structures were washed in acetonitrile and dried at in an oven at 40° C. The chronoamperometry results along with the microscopy images of the dry structures can be seen in FIG. 9 and FIG. 10, respectively.

### Example 5: Fabrication of Polypyrrole Structure

An acetonitrile solution comprising pyrrole (47-400 mM) and TBAHFP (0.1M) was added to the container in the 3D printer as described above. The electrode was a 370 μm diameter glassy platinum electrode and the substrate was aluminium, steel or ITO. The electrode was positioned at a starting distance of from about 10 to 500 μm away from the substrate. The potential difference between the substrate and electrode was typically cycled at a voltage range of about 2.5 to 5.0 V. The printing speed was 0.24 mm/min.

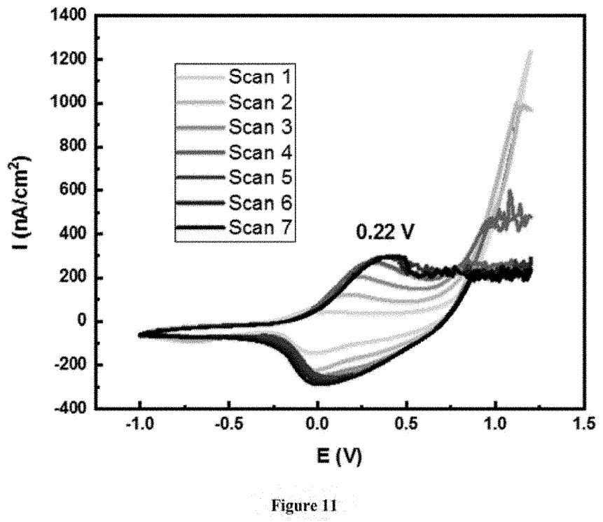

The example cyclic voltammetry plot at FIG. 11 shows the potential difference cycling from −1.0 V to 1.3 V, showing the oxidation of pyrrole at 0.22V to form polypyrrole according to the reaction scheme below.

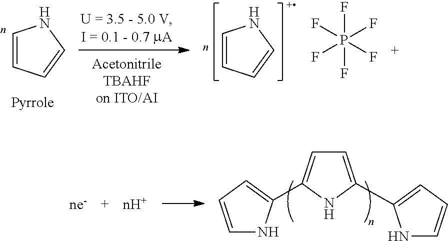

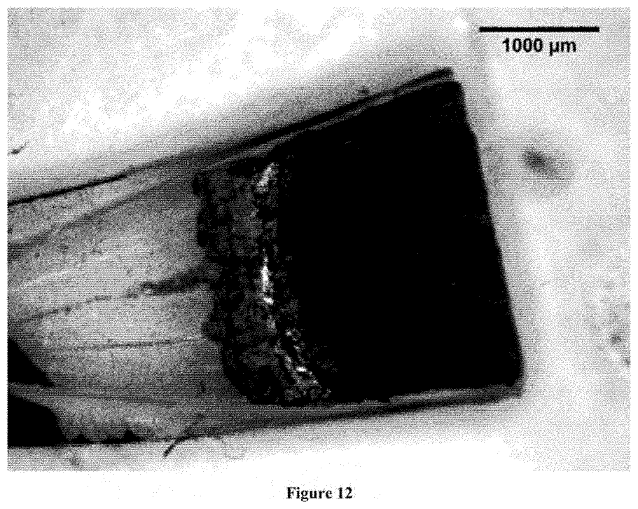

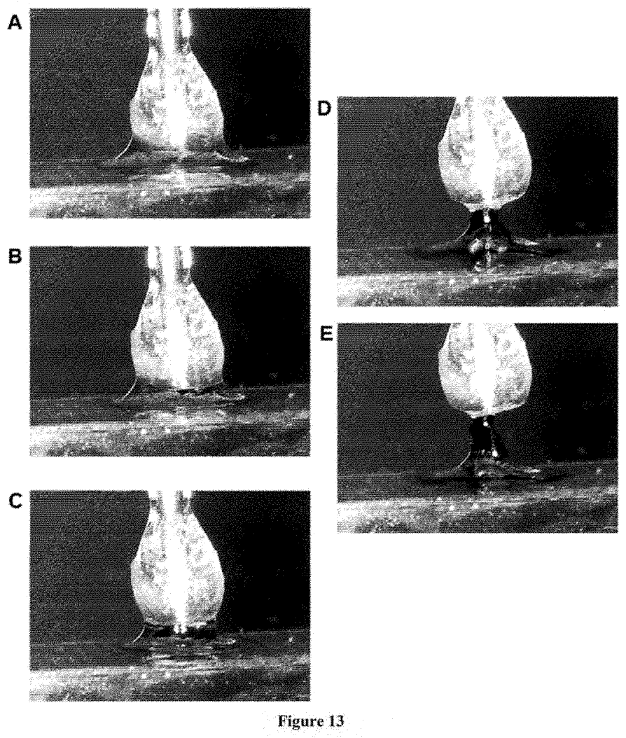

A polypyrrole structure formed using the method is shown in FIG. 12. FIG. 13 shows time lapse images of the deposition of polypyrrole on ITO taken at: (A) 0 seconds, (B) 95 seconds, (C) 205 seconds, (D) 369 seconds, and (E) 410 seconds show the printed polypyrrole from a 400 mM pyrrole solution forming a 1.675 mm high pillar structure on ITO.

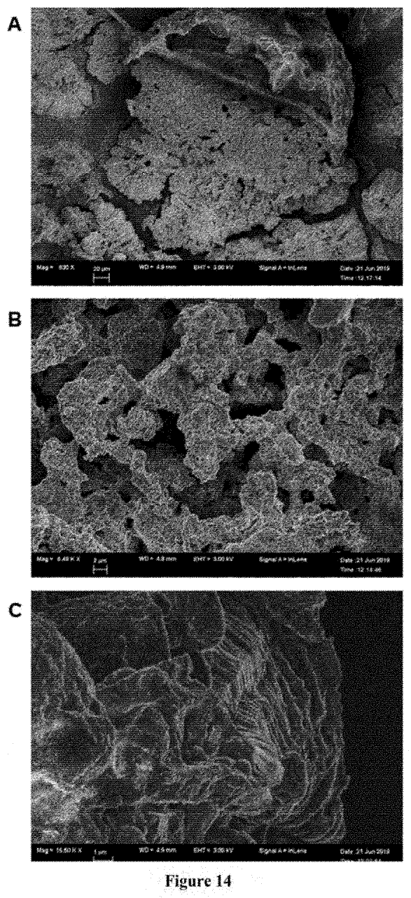

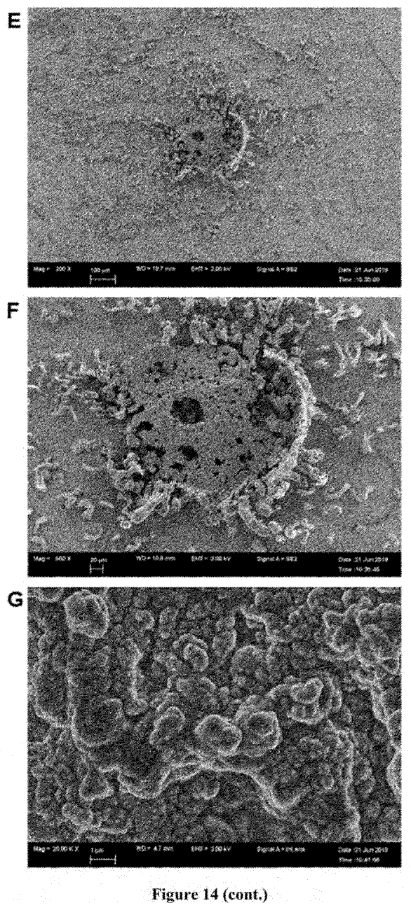

Scanning electron micrographs of polypyrrole structures printed according to the method are shown in FIG. 14 at: (A) 200×; (B) 2000×; (C) 20,000×; (D) 630×; (E) 5480×; and (F) 15,500× magnification. These images show a layered deposition of the polypyrrole structure.

### Example 6: Fabrication of PEDOT Structure

An acetonitrile solution comprising EDOT (70-400 mM) and TBAHFP (0.1M) was added to the container in the 3D printer as described above. The electrode was a 370 μm diameter glassy platinum electrode and the substrate was aluminium, steel, gold, or ITO. The electrode was positioned at a starting distance of from about 10 to 500 μm away from the substrate. The potential difference between the substrate and electrode was typically cycled at a voltage range of about 2.7-6.5 V. The printing speed was about 0.2-5 mm/min.

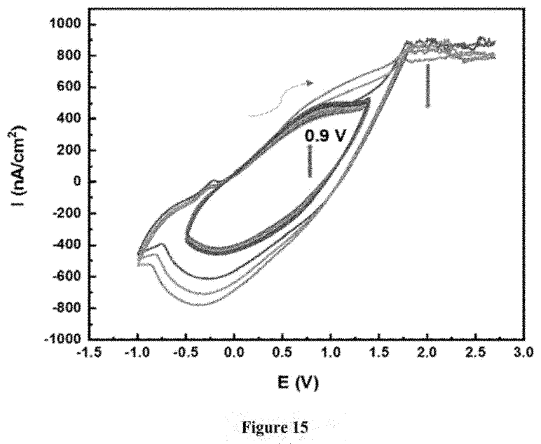

The example cyclic voltammetry plot at FIG. 15 shows the potential difference cycling from −1.0 V to 2.7 V, showing the oxidation of EDOT at 0.9V to form PEDOT according to the reaction scheme below.

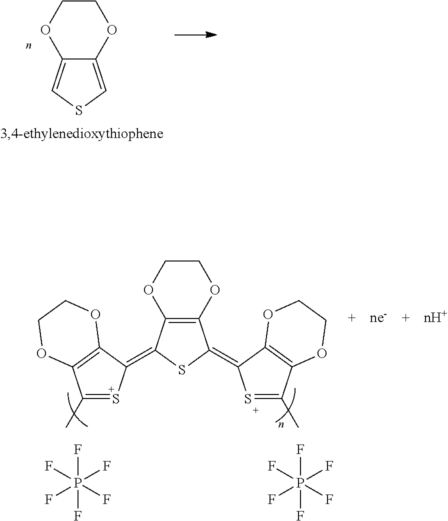

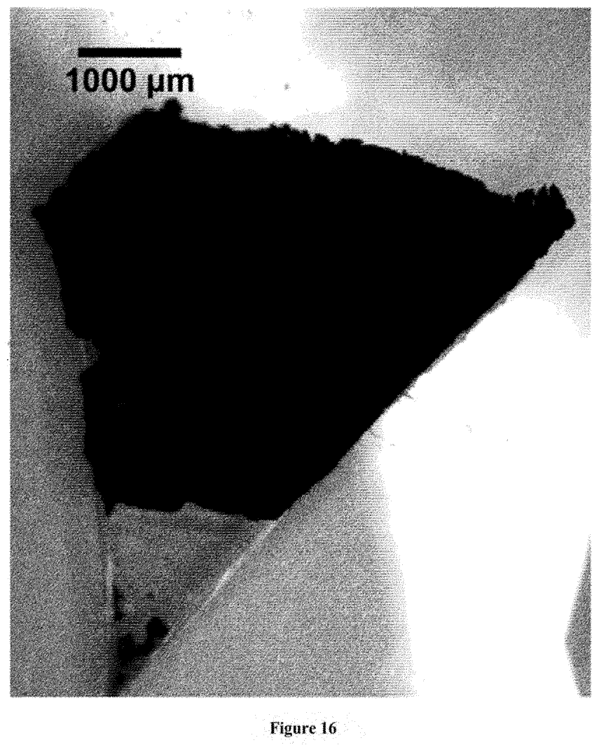

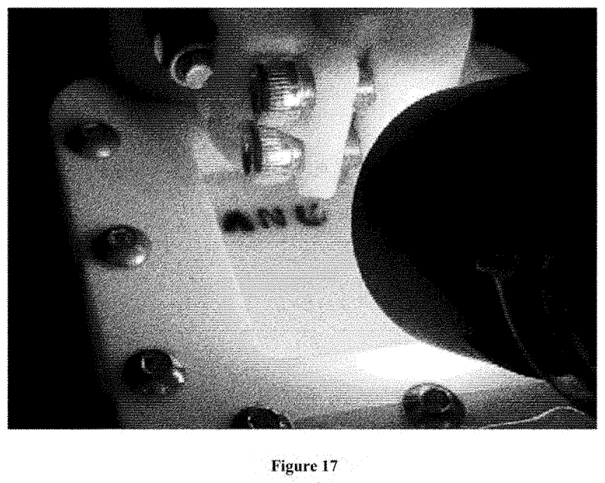

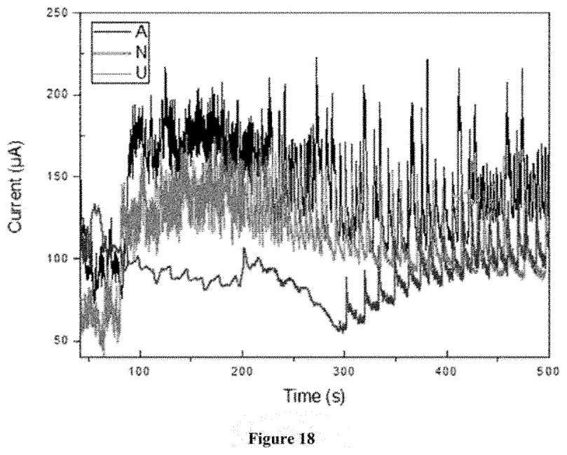

A PEDOT structure formed using the printing method is shown in FIG. 16. The method was used to print the text “ANU” as shown in FIG. 17. Chronoamperometry plots for each letter formed using the PEDOT printing method are shown at FIG. 18. Chronoamperometry of each structure can be used as a real-time in situ monitoring method to detect structural defects.

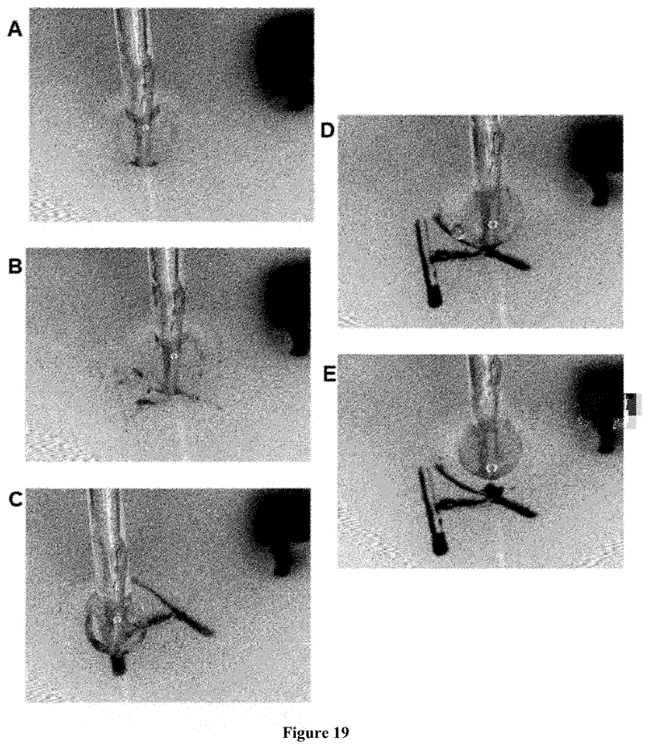

FIG. 19 shows time lapse images of the deposition of PEDOT on ITO taken at: (A) 0 seconds, (B) 15 seconds, (C) 44 seconds, (D) 115 seconds, and (E) 169 seconds that show the printed PEDOT from a 70 mM solution of EDOT forming a letter “A” layer by layer.

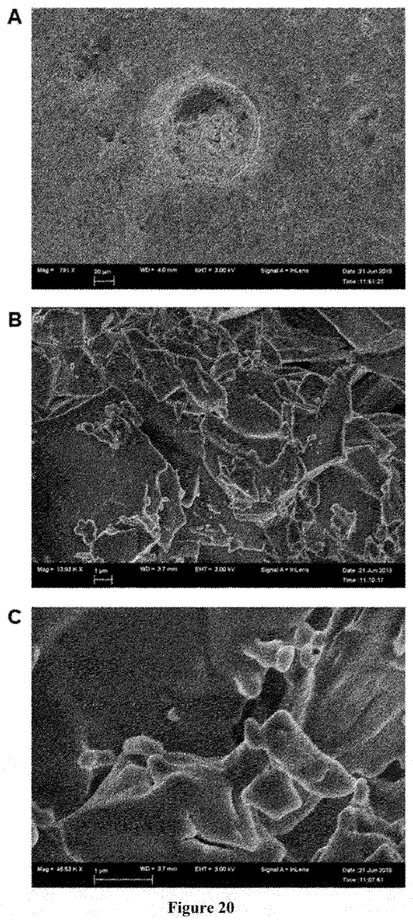

Scanning electron micrographs of a PEDOT pillar printed according to the method are shown in FIG. 20 at: (A) 791×; (B) 13,930×; and (C) 46,530× magnification.

### Example 7: Fabrication of Polythiophene Structure

An acetonitrile solution comprising thiophene (400 mM) and TBAHFP (0.1M) was added to the container in the 3D printer as described above. The electrode was a 370 μm diameter glassy platinum electrode and the substrate was ITO. The electrode was positioned at a starting distance of from about 10 to 500 μm away from the substrate. The potential difference between the substrate and electrode was typically cycled at a voltage range of about 1.0-7.0 V. The printing speed was about 0.24 mm/min.

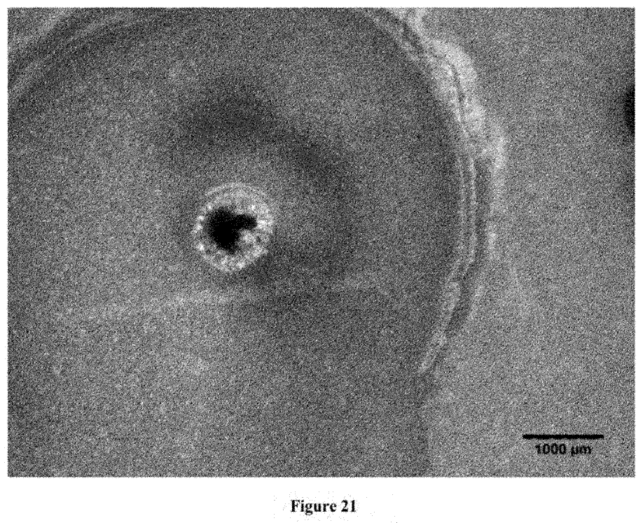

A polythiophene pillar structure on ITO, formed from a 400 mM thiophene solution using the printing method, is shown in FIG. 21.

### Example 8: Fabrication of Polyaniline Structure

An acetonitrile solution comprising aniline (400 mM) and TBAHFP (0.1M) was added to the container in the 3D printer as described above. The electrode was a 370 μm diameter glassy platinum electrode and the substrate was ITO. The electrode was positioned at a starting distance of from about 10 to 500 μm away from the substrate. The potential difference between the substrate and electrode was typically cycled at a voltage range of about 1.0-11.0 V. The printing speed was about 0.24 mm/min.

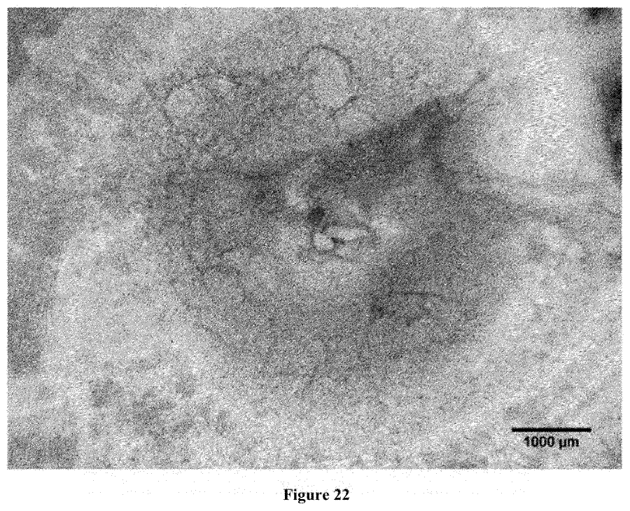

A polyaniline pillar structure on ITO, formed from a 400 mM aniline solution using the printing method, is shown in FIG. 22.

### Example 9: Fabrication of Polyvinylimidazole Structure

An acetonitrile solution comprising vinylimidazole (200 mM) and TBAHFP (0.1M) was added to the container in the 3D printer as described above. The electrode was a 370 μm diameter glassy platinum electrode and the substrate was ITO. The electrode was positioned at a starting distance of from about 10 to 500 μm away from the substrate. The potential difference between the substrate and electrode was typically cycled at a voltage range of about 1.0-5.0 V. The printing speed was about 0.24 mm/min.

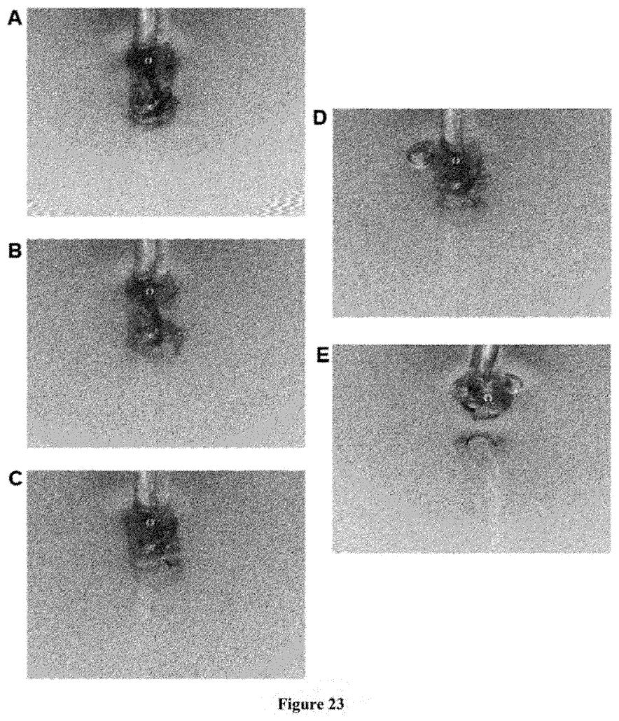

FIG. 23 shows time lapse images of the deposition of polyvinylimidazole on ITO taken at: (A) 0 seconds, (B) 40 seconds, (C) 90 seconds, (D) 180 seconds, and (E) 207 seconds that show the printed polyvinylimidazole from a 200 mM solution of vinylimidazole.

### Example 10: Fabrication of PEDOT and Polyvinylimidazole Composite Structure

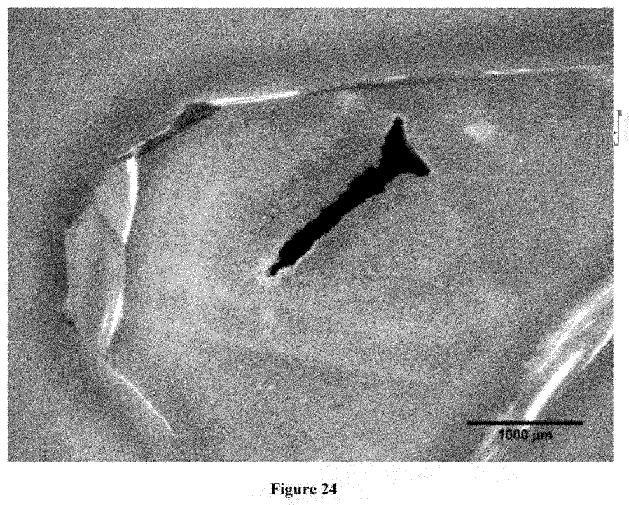

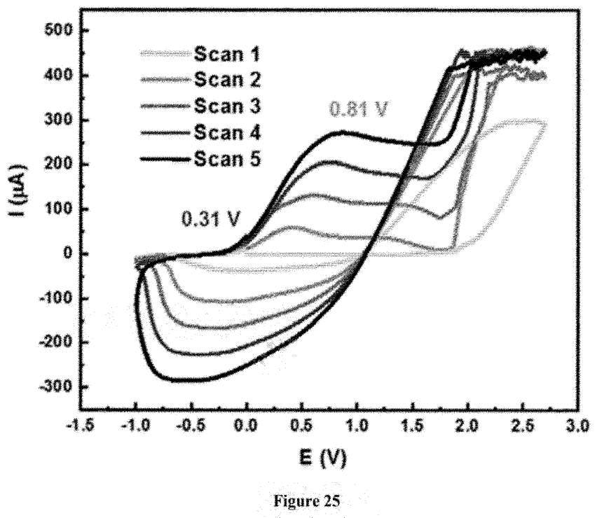

A composite structure made of multiple materials was printed using a single bath comprising EDOT and vinylimidazole. Printing at lower potentials enabled deposition of PVI, while higher potentials resulted in deposition of PEDOT. A PEDOT/PVI composite structure formed using the printing method is shown in FIG. 24. The example cyclic voltammetry plot at FIG. 25 shows the potential difference cycling from −1.0 V to 2.7 V, showing the oxidation of EDOT at 0.81V to form PEDOT and the oxidation of vinylimidazole at 0.31V to form PVI. Accordingly, it is possible to tune the voltage cycling during use of the printer to selectively deposit one or more different materials from the solution in the container of the 3D printer.

### Example 11: Fabrication of Copper Structure

An acetonitrile solution comprising Cu²⁺ (1.28 M) and TBAHFP (0.097M) was added to the container in the 3D printer as described above. The electrode was a 370 μm diameter glassy platinum electrode and the substrate was ITO. The electrode was positioned at a starting distance of from about 10 to 500 μm away from the substrate. The potential difference between the substrate and electrode was typically cycled at a voltage range of about −0.7 to about −4.5 V. The printing speed was about 0.56 mm/min.

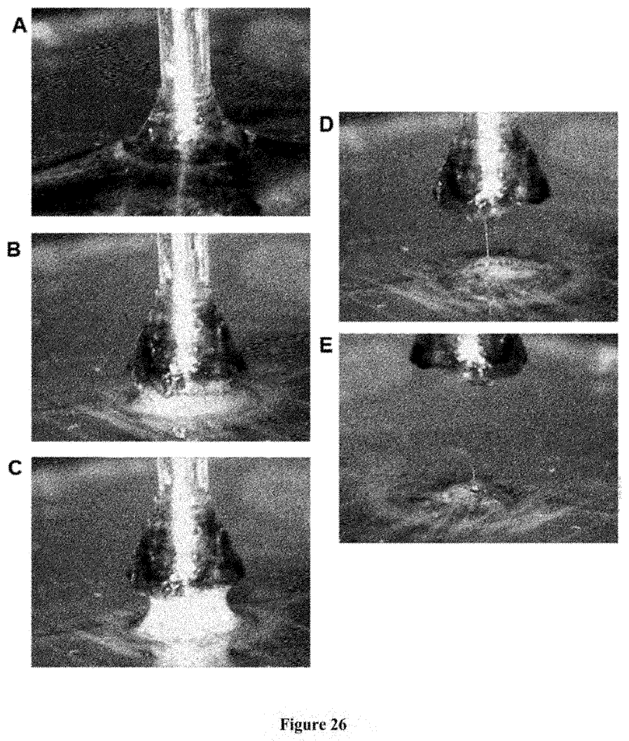

FIG. 26 shows time lapse images of copper being deposited on ITO at: (A) 0 seconds; (b) 60 seconds; (C) 90 seconds; (D) 160 seconds; and (E) 200 seconds.

### Example 12: Fabrication of PEDOT and Copper Structure

A composite structure made of multiple materials was printed using a single bath comprising EDOT and Cu²⁺. A 1.28 M saturated copper (II) sulfate solution was prepared by dissolving copper (II) sulfate and concentrated sulfuric acid (0.94 M) in aniline and stirring the solution overnight. EDOT and TBAHFP were dissolved in aniline in concentrations of 70 mM and 97 mM respectively. This solution was stirred for 30 minutes at room temperature. The EDOT and copper (II) sulfate solutions were mixed in a 1:1 volume ratio and transferred to the 3D printer container. Printing at negative potentials enabled deposition of copper, while printing at positive potentials resulted in deposition of PEDOT.

It will be appreciated that, although specific embodiments of the invention have been described herein for the purpose of illustration, various modifications may be made without deviating from the spirit and scope of the invention as defined in the following claims. For example, the skilled person will understand that different materials may be printed using this method by tuning the electric potential applied between the electrode and substrate in relation to the respective oxidation and/or reduction potentials of the relevant precursor agents in a single bath solution. Alternatively, the 3D printer may be used with multiple baths, each having a different precursor therein, and one material may be deposited, before a second or third material is subsequently deposited from a different bath solution.

The method disclosed herein may provide one or more of the following advantages:
Electrodeposition of materials from liquid precursor baths (baths of electrodepositable material) in a precise, three-dimensionally controlled printing method.
The ability to monitor and control deposition processes in situ (using methods including cyclic voltammetry and amperometry), which may allow precise monitoring of reactions at precursor agent concentrations as low as 10⁻³ to 10⁻⁵ M.
The ability to produce highly electrically conductive polymer structures in a range of 3D geometries by in situ polymerization, whilst retaining the high conductivity of the polymer. Polymers made in this fashion may generally be more conductive than comparable polymers made by chemical processes.
This method can also be generalized to a range of other chemical reactions that are initiated by current (not limited to polymerisation reactions and purely conducting polymers). Multiple materials (including metals, polymers and semiconducting ceramics) may be deposited in precise geometries using this technique.
Precise, feedbacked control of the deposition parameters may allow for multiple, different materials to be sequentially deposited from a single deposition bath, or via the use of multiple deposition baths. This would greatly reduce the manufacturing complexity and cost for complex, multicomponent structures.
There may be an additional benefit of being able to electrochemically modify either the substrate or any previously printed conducting material with organic molecules in order to modify surface properties, introduce more biocompatibility or other functionality into the printed objects (e.g. electrochemical immobilization).

1. A method for forming a multidimensional structure, the method comprising the following steps:
providing an electrode and a substrate in a fluid,
wherein the fluid comprises:
an electrolyte, and
a precursor agent dispersed therein;
applying an electric potential difference between the substrate and the electrode to reduce or oxidise the precursor agent, thereby depositing a solid material;
measuring current between the substrate and the electrode; and
moving the electrode within the fluid to form a multidimensional structure of the solid material.

2. The method of claim 1, wherein the current between the substrate and the electrode is measured at a plurality of time points.

3. (canceled)

4. The method of claim 1, wherein the current between the substrate and the electrode is measured as a function of time.

5. The method of claim 1, further comprising varying one or more of the electrical potential difference between the substrate and the electrode, and the position of the electrode when the current is above, below, or at a predetermined value.

6-11. (canceled)

12. The method of claim 1, wherein the precursor agent is selected from the group consisting of metal salts and monomeric materials.

13. The method of claim 1, wherein the concentration of the precursor agent in the fluid is from about 10⁻⁵ M to about 1.5 M.

14. The method of claim 1, wherein the fluid is in a container, and the electrode and substrate are within the fluid in the container.

15. The method of claim 1, wherein the fluid comprises an organic solvent.

16. (canceled)

17. The method of claim 1, wherein the fluid does not comprise water.

18. The method claim 1, wherein the solid material is selected from the group consisting of vinyl polymers, conjugated polymers, metals, and combinations thereof.

19. (canceled)

20. The method of claim 1, wherein the precursor agent is selected from the group consisting of metal ion salts, metal ion complexes, ionic liquids, vinyl monomers, and monomers of conjugated polymers.

21-22. (canceled)

23. The method of claim 1, wherein the fluid is a first fluid, and the method further comprises:
replacing the first fluid with a second fluid, wherein the second fluid comprises:
an electrolyte, and
a precursor agent dispersed therein, wherein the precursor agent of the second fluid is different to the precursor agent of the first fluid; and
applying an electrical potential difference between the electrode and the substrate to reduce or oxidise the precursor agent of the second fluid, thereby depositing a second solid material.

24. The method of claim 1, wherein the fluid comprises a first precursor agent and a second precursor agent, and the method comprises:
applying a first electrical potential difference between the electrode and the substrate to reduce or oxidise the first precursor agent, thereby depositing a first solid material; and
applying a second electrical potential difference between the electrode and the substrate to reduce or oxidise the second precursor agent, thereby depositing a second solid material.

25-26. (canceled)

27. The method of claim 1, wherein the surface area of the electrode is from about 10⁻⁹ m² to about 10⁻⁴ m².

28-32. (canceled)

33. A device for producing a multidimensional structure, said device comprising:
an electrode;
a container for holding a fluid;
one or more motors for moving the electrode within the container;
a substrate within the container; and
a potentiostat for applying an electric potential difference between the substrate and the electrode and for measuring current between the substrate and the electrode.

34. The device of claim 33, further comprising a reference electrode in electrical connection to the potentiostat.

35. The device of claim 33, further comprising a quartz crystal microbalance (QCM) for measuring the mass of the multidimensional structure.

36. (canceled)

37. The device of claim 33, which is a 3D printer.

38-43. (canceled)

44. The method of claim 1, further comprising controlling printing parameters based on the current measured between the substrate and the electrode.

45. The device of claim 33, further comprising a controller that controls printing parameters based on the current measured between the substrate and the electrode.
